(19) United States
(12) Patent Application Publication
(10) Pub. No.: US 2011/0111277 A1
(43) Pub. Date: May 12, 2011

(54) CURRENT COLLECTOR FOR NON-AQUEOUS ELECTROLYTE SECONDARY BATTERY, ELECTRODE FOR NON-AQUEOUS ELECTROLYTE SECONDARY BATTERY, PRODUCTION METHODS THEREOF, AND NON-AQUEOUS ELECTROLYTE SECONDARY BATTERY

(76) Inventors: Kunihiko Bessho, Osaka (JP); Daisuke Suetsugu, Osaka (JP); Seiichi Kato, Osaka (JP)

(21) Appl. No.: 13/054,146

(22) PCT Filed: Jul. 21, 2009
(86) PCT No.: PCT/JP2009/003412

§ 371 Date: Jan. 14, 2011

(30) Foreign Application Priority Data
Jul. 29, 2008 (JP) 2008-194474
Aug. 28, 2008 (JP) 2008-219164

(51) Int. Cl. H01M 4/70; H01M 4/485; H01M 2/02; B21D 31/00; H01M 10/36; H01M 4/04

(52) U.S. Cl. 429/94; 429/233; 429/231.1; 429/185; 29/623.1; 72/379.2; 29/623.5

(57) ABSTRACT

A current collector includes a metal foil and protrusions formed on one face or both faces of the metal foil in a predetermined arrangement. The protrusions are substantially rhombic and aligned in a zigzag. Also, both end portions of each protrusion in each of two orthogonal axial directions protrude outward. Middle portions between the end portions are recessed inward. When columnar blocks of an active material are formed on the protrusions to form an active material layer, the gaps between the protrusions can be increased at portions where the interval between the protrusions is the smallest. As a result, internal stress of the active material layer created by charge/discharge of the battery can be alleviated, and the battery life can be increased.

### TECHNICAL FIELD

This invention relates to non-aqueous electrolyte secondary batteries represented by lithium ion secondary batteries, and more particularly to a technique for improving the ability of current collectors used therein to hold an active material.

### BACKGROUND ART

In recent years, lithium ion secondary batteries have been widely used as the power source for portable electronic devices. Lithium ion secondary batteries use a carbonaceous material or the like capable of absorbing and desorbing lithium as a negative electrode active material, while using a composite oxide containing a transition metal and lithium (a lithium-containing transition metal oxide) such as LiCoO₂ as a positive electrode active material. This allows lithium ion secondary batteries to have battery characteristics of high voltage and high discharge capacity.

However, with the recent trend of electronic devices and communications devices becoming increasingly more multifunctional, secondary batteries such as lithium ion secondary batteries are required to provide a further improvement in battery performance. In particular, they are required to provide a further improvement with respect to performance deterioration due to repeated charge/discharge (hereinafter referred to as charge/discharge cycles).

Performance deterioration of lithium ion secondary batteries due to charge/discharge cycles is briefly described below.

Electrodes (positive and negative electrodes) of lithium ion secondary batteries, which are power generating elements thereof, are usually produced as follows.

An electrode mixture slurry is prepared by dispersing a positive electrode active material or negative electrode active material, a binder, and optionally a conductive agent in a dispersion medium. The prepared electrode mixture slurry is applied onto one or both faces of a current collector and dried to form an active material layer. The current collector with the active material layer is pressed so that the total thickness is a predetermined value.

One cause of performance deterioration of an electrode, produced in such a process, due to charge/discharge cycles is a decrease in the adhesion between the active material layer and the current collector. More specifically, charge/discharge causes the active material layer to repeatedly expand and contract, thereby weakening the adhesion at the interface between the active material layer and the current collector and causing the active material layer to fall off the current collector. In this manner, battery performance deteriorates.

Therefore, in order to suppress performance deterioration due to charge/discharge cycles, it is necessary to increase the adhesion between the current collector and the active material layer, and to do this, it is effective to increase the contact area at the interface between the current collector and the active material layer. Specifically, the surface of a current collector is usually roughened by etching the current collector surface by electrolysis, or depositing the constituent metal of the current collector on the current collector surface by electrodeposition.

In one proposal, fine particles are caused to collide with the surface of a rolled copper foil at a high speed to form minute protrusions and depressions on the surface (see Patent Document 1).

In another proposal, a metal foil is irradiated with a laser beam to form protrusions and depressions so that the surface roughness (arithmetic mean roughness) is 0.5 to 10 μm (see Patent Document 2).

In still another proposal, immediately before a current collector unwound from a supply roller is coated with an electrode mixture slurry by a coater, protrusions and depressions are formed on the surfaces of the current collector by a pair of guide rollers (see Patent Document 3).

In still another proposal, in order to improve the adhesion between a current collector and an active material layer and electrical conductivity, protrusions and depressions are regularly formed on both faces of the current collector in such a manner that where there is a depression in one face, there is a protrusion on the other face (see Patent Document 4).

In still another proposal, a current collector is embossed to form protrusions and depressions (see Patent Document 5).

Another known method for producing an electrode of a lithium secondary battery, which is a power generating element thereof, is a method of forming an active material layer on a current collector by a process such as electrolytic plating or vacuum deposition. This method also needs to increase the adhesion between the current collector and the active material layer to provide a stable battery. Thus, the method proposes setting the value obtained by subtracting the surface roughness (Ra) of the current collector from the surface roughness (Ra) of the active material layer to 0.1 μm or less (see Patent Document 6).

Currently, a carbonaceous material (e.g., graphite) is mainly used as the negative electrode active material for lithium ion secondary batteries. Due to the theoretical capacity of the material, battery capacity is about to reach its limit. Hence, in order to achieve an even higher capacity, it is necessary to use other materials as negative electrode active materials, and alloyable materials are receiving attention as such materials (see Patent Document 7).

Alloyable materials are capable of absorbing large amounts of lithium and thus providing high capacities. However, when they absorb and desorb lithium ions due to charge/discharge, they expand and contract significantly, thereby causing the electrode thickness to change significantly due to charge/discharge.

There is thus a concern that they may cause separation of the active material from the current collector, occurrence of wrinkles in the current collector, uneven charge/discharge reactions, deterioration of charge/discharge cycle characteristics, etc.

To address such problems resulting from the significant expansion and contraction of alloyable materials due to charge/discharge, an electrode structure illustrated in FIG. 25 has been proposed (see Patent Document 8).

Therein, a large number of protrusions 202 are formed on a surface of a negative electrode current collector 200 made of metal foil, and a columnar block 204 is formed on each of the protrusions 202 to provide a negative electrode active material layer 206 comprising a group of the columnar blocks 204. The columnar blocks 204 are separated from one another, and gaps 208 between them become wider from the surface of the active material layer 206 downward in the thickness direction of the active material layer 206.

As described above, when the active material layer is composed of a large number of columnar blocks with gaps therebetween, changes in the thickness of the active material layer caused by the expansion and contraction of the active material due to charge/discharge can be suppressed.

### CITATION LIST

### Patent Literatures

[PTL 1] Japanese Laid-Open Patent Publication No. 2002-79466
[PTL 2] Japanese Laid-Open Patent Publication No. 2003-258182
[PTL 3] Japanese Laid-Open Patent Publication No. Hei 8-195202
[PTL 4] Japanese Laid-Open Patent Publication No. 2002-270186
[PTL 5] Japanese Laid-Open Patent Publication No. 2005-32642
[PTL 6] Japanese Laid-Open Patent Publication No. 2002-279974
[PTL 7] Japanese Laid-Open Patent Publication No. 2002-83594
[PTL 8] Japanese Laid-Open Patent Publication No. 2002-313319

### SUMMARY OF INVENTION

### Technical Problem

However, according to the above-mentioned conventional techniques, protrusions and depressions are formed in such a manner that where there is a depression in one face of a metal foil current collector, there is necessarily a protrusion on the other face. It is thus difficult to prevent the current collector from having problems such as becoming wavy, wrinkled, or warped.

Also, according to the conventional technique of PTL 2, depressions are formed by irradiating a metal foil with a laser to locally heat the metal foil and evaporate the metal. At this time, when the metal foil is continuously irradiated with a laser to form protrusions and depressions over the whole surface of the metal foil, if the metal foil is scanned with the laser in the form of a line, the portion along the line may be heated to a temperature that is equal to or higher than the melting point. As a result, the metal foil has problems such as becoming wavy, wrinkled, or warped. Further, the current collectors for lithium ion secondary batteries are usually made of a metal foil with a thickness of 20 μm or less, and when such a metal foil is irradiated with a laser, a hole may be made in the metal foil due to variation in the output of the laser.

According to the conventional techniques of PTLs 3 and 4, where there is a depression in the surface of a metal foil, there is necessarily a protrusion on the back face, and it is thus difficult to prevent the metal foil from having problems such as becoming wavy, wrinkled, or warped.

According to the conventional technique of PTL 5, a perforated metal with an open area ratio of 20% or less is embossed to form protrusions and depressions. Thus, the current collector has a low strength, which can cause a problem such as breakage of the electrode.

According to the conventional technique of PTL 6, the adhesion between a current collector and an active material layer is stabilized by setting the value obtained by subtracting the surface roughness (Ra) of the current collector from the surface roughness (Ra) of the active material layer to 0.1 μm or less. However, if the active material layer contains a metal which expands significantly upon lithium intercalation, the adhesion between the current collector and the active material layer becomes weak, so the electrode becomes wrinkled, which may cause a problem of deterioration of charge/discharge cycle characteristics.

According to the conventional technique of PTL 7, an active material layer is composed of a large number of columnar blocks with gaps therebetween to absorb stress exerted by the expansion of the active material during charge. Thus, fall-off of the active material layer and occurrence of wrinkles in the current collector due to charge/discharge cycles can be suppressed at least during an early stage.

However, since lithium ion secondary batteries, which represent non-aqueous electrolyte secondary batteries, need to be mass produced, they require a simple production process. Hence, a can roll method is usually employed to form a negative electrode active material layer using an alloyable material. In the can roll method, while a current collector shaped like a long strip is being transported in the longitudinal direction, an active material layer is continuously formed on a surface of the current collector by a thin-film forming process such as vapor deposition, sputtering, or CVD.

However, according to the can roll method, the columnar blocks constituting the active material layer gradually grow not only in the thickness direction of the active material layer but also in the plane direction thereof. Thus, the columnar blocks become wider toward their ends, i.e., toward the surface side of the active material layer. As a result of this phenomenon, the gaps between the adjacent columnar blocks become small near the surface of the active material layer. As such, when charge/discharge is repeated, the adjacent columnar blocks are compressed with one another, thereby resulting in such problem as cracking of the columnar blocks.

For example, the volume expansion rate of silicon negative electrode active material in a fully charged state compared with a fully discharged state reaches 400%. In particular, when the thickness of the active material layer is increased to provide high capacity, the above-mentioned stress becomes large, thereby making it difficult to suppress occurrence of wrinkles in the current collector and fall-off of the active material layer.

Also, since the gaps are formed between the columnar blocks constituting the active material layer, the stress inside the active material layer during charge can be suppressed at least in an early state. However, it is difficult to suppress the stress on a long term, since the columnar blocks gradually expand upon repeated charge/discharge.

Also, a problem with the use of an alloyable material as the negative electrode active material is a large irreversible capacity. When the negative electrode has a large irreversible capacity, much of the reversible capacity of the positive electrode is consumed by the irreversible capacity of the negative electrode. Therefore, supplementation of lithium to the negative electrode active material layer is necessary to realize a high capacity non-aqueous electrolyte secondary battery using an alloyable material.

Supplementation of lithium to the negative electrode active material layer can be made, for example, by depositing lithium on the surface of the negative electrode active material layer by vacuum deposition. The deposited lithium is absorbed by the negative electrode active material through a solid phase reaction with the negative electrode active material. However, when the negative electrode active material is supplemented with lithium, the columnar blocks of the active material expand, so the adjacent columnar blocks come into contact with one another, thereby creating a stress therebetween. As a result, in the case of forming an active material layer on each face of a current collector, if the amounts of active material supported on one face and the other face are uneven, the above-mentioned stress is distributed unevenly, thereby resulting in problems such as the electrode becoming wavy.

The invention is made in view of the problems as described above. An object of the invention is to provide a current collector for a non-aqueous electrolyte secondary battery which can suppress occurrence of problems such as an electrode becoming wavy, wrinkled, or warped and which can suppress fall-off of the active material layer due to charge/discharge. Another object of the invention is to provide a highly safe electrode for a non-aqueous electrolyte secondary battery and a highly safe non-aqueous electrolyte secondary battery which use such a current collector. Still another object of the invention is to provide a method for producing such a current collector for a non-aqueous electrolyte secondary battery and a method for producing such an electrode for a non-aqueous electrolyte secondary battery.

### Solution to Problem

To solve the above-described problems, the invention provides a current collector for a non-aqueous electrolyte secondary battery, including: a metal foil; and a plurality of protrusions formed on at least one face of the metal foil. Each of the protrusions, when viewed from a direction perpendicular to a surface of the metal foil, has such a shape that both end portions in each of two orthogonal axial directions protrude outward while middle portions between the end portions that are adjacent in a circumferential direction of the protrusion are recessed inward.

In a preferable embodiment of the current collector for a non-aqueous electrolyte secondary battery according to the invention, the protrusions are aligned on the surface of the metal foil in a zigzag.

In another preferable embodiment of the current collector for a non-aqueous electrolyte secondary battery according to the invention, the end portions of each of the protrusions in each of the two axial directions have the same height, and the end portions in one of the two axial directions have a greater height than the end portions in the other axial direction.

In still another preferable embodiment of the current collector for a non-aqueous electrolyte secondary battery according to the invention, each of the protrusions has a main top face between the end portions in the one axial direction, and the height of the main top face is equal to or greater than that of the end portions in the one axial direction. The end portions in the other axial direction are disposed on both sides of the main top face.

In still another preferable embodiment of the current collector for a non-aqueous electrolyte secondary battery according to the invention, the main top face has an indentation adjacent to each of the end portions in the other axial direction, and at least a part of the indentation is spherical.

In still another preferable embodiment of the current collector for a non-aqueous electrolyte secondary battery according to the invention, at least a side face of each of the middle portions of the protrusions is slanted in such a manner that it is gradually recessed inward toward a top.

In still another preferable embodiment of the current collector for a non-aqueous electrolyte secondary battery according to the invention, the protrusions are formed by applying a compression process to the metal foil, and top faces of the protrusions maintain the surface roughness of the metal foil which has not been subjected to the compression process.

The invention also provides a current collector for a non-aqueous electrolyte secondary battery, including: a metal foil; and a plurality of protrusions formed on at least one face of the metal foil. Each of the protrusions has a plurality of projections on a top face.

In a preferable embodiment of the current collector for a non-aqueous electrolyte secondary battery according to the invention, the projections are arranged regularly on the top faces of the protrusions.

In another preferable embodiment of the current collector for a non-aqueous electrolyte secondary battery according to the invention, the projections are arranged irregularly on the top faces of the protrusions.

In still another preferable embodiment of the current collector for a non-aqueous electrolyte secondary battery according to the invention, the projections have a height of 1 to 5 μm.

In still another preferable embodiment of the current collector for a non-aqueous electrolyte secondary battery according to the invention, the interval between the adjacent projections is 1 to 5 μm.

The invention also provides an electrode for a non-aqueous electrolyte secondary battery, including: the above-mentioned current collector for a non-aqueous electrolyte secondary battery; and a positive electrode active material comprising a lithium-containing transition metal oxide, or a negative electrode active material comprising a material capable of retaining lithium, the active material being carried on the current collector.

The invention further provides a non-aqueous electrolyte secondary battery including: an electrode assembly comprising a positive electrode, a negative electrode, and a separator interposed between the two electrodes, which are layered or wound; a non-aqueous electrolyte; a battery case with an opening for housing the electrode assembly and the non-aqueous electrolyte; and a seal member for sealing the opening. At least one of the positive electrode and the negative electrode comprises the above-mentioned electrode for a non-aqueous electrolyte secondary battery.

The invention also provides a method for producing a current collector for a non-aqueous electrolyte secondary battery, including the steps of:

(a) compressing a metal foil by a pair of rollers at least one of which has a plurality of depressions to form a plurality of projections on at least one face of the metal foil; and

(b) compressing the metal foil by another pair of rollers at least one of which has a plurality of depressions to form protrusions on the face of the metal foil having the projections, the protrusions being larger in size than the projections.

In a preferable embodiment of the method for producing a current collector for a non-aqueous electrolyte secondary battery according to the invention, the depressions are formed in the roller by at least one selected from the group consisting of laser machining, etching, dry etching, and blasting.

The invention also provides an electrode for a non-aqueous electrolyte secondary battery, including: a current collector comprising a metal foil and a plurality of protrusions formed on both faces of the metal foil in a predetermined arrangement; and active material layers formed on both faces of the current collector. Each of the active material layers is a group of columnar blocks of an active material formed on the protrusions, and the thickness of the active material layer on one face of the current collector is greater than that of the active material layer on the other face.

In a preferable embodiment of the electrode for a non-aqueous electrolyte secondary battery according to the invention, the active material layers comprise a compound containing silicon and oxygen or a compound containing tin and oxygen.

In another preferable embodiment of the electrode for a non-aqueous electrolyte secondary battery according to the invention, the columnar blocks extend from top faces of the protrusions slantwise with respect to a direction perpendicular to a surface of the metal foil.

In still another preferable embodiment of the electrode for a non-aqueous electrolyte secondary battery according to the invention, the thickness of the active material layer on one face of the current collector is smaller than that of the active material layer on the other face by 5 to 10%.

In still another preferable embodiment of the electrode for a non-aqueous electrolyte secondary battery, the invention provides a non-aqueous electrolyte secondary battery including: an electrode assembly comprising a positive electrode, a negative electrode, and a separator interposed between the two electrodes, which are wound; a non-aqueous electrolyte; a battery case with an opening for housing the electrode assembly and the non-aqueous electrolyte; and a seal member for sealing the opening. The negative electrode comprises the above-mentioned electrode for a non-aqueous electrolyte secondary battery, and the electrode assembly is produced by winding the negative electrode so that the active material layer on the one face is positioned on the inner side while the active material layer on the other face is positioned on the outer side.

In still another preferable embodiment of the electrode for a non-aqueous electrolyte secondary battery according to the invention, the positive electrode has active material layers on both faces, and the amount of active material contained in the active material layer on one face of the positive electrode is smaller than that of the active material layer on the other face. The electrode assembly is produced by winding the positive electrode so that the active material layer on the one face is positioned on the outer side while the active material layer on the other face is positioned on the inner side.

The invention also provides a method for producing an electrode for a non-aqueous electrolyte secondary battery, including the steps of:

(a) preparing a current collector comprising a long-strip like metal foil and a plurality of protrusions formed on both faces of the metal foil in a predetermined arrangement;

(b) preparing a silicon- or tin-containing raw material for active material;

(c) evaporating the raw material for active material from a deposition source in a vacuum deposition chamber;

(d) transporting the current collector in a longitudinal direction in the vacuum deposition chamber;

(e) supplying oxygen to a vicinity of the current collector in the vacuum deposition chamber; and

(f) depositing the raw material for active material on a surface of the current collector to form an active material layer. When the active material layer is formed on both faces of the current collector, the raw material for active material is deposited on the current collector so that the thickness of the active material layer formed on one face of the current collector is smaller than that of the active material layer formed on the other face of the current collector.

In a preferable embodiment of the method for producing an electrode for a non-aqueous electrolyte secondary battery according to the invention, when the active material layer is formed on one face of the current collector, the current collector is transported at a lower speed than when the active material layer is formed on the other face of the current collector.

In another preferable embodiment of the method for producing an electrode for a non-aqueous electrolyte secondary battery according to the invention, when the active material layer is formed on one face of the current collector, the deposition source is heated with a larger amount of heat than when the active material layer is formed on the other face of the current collector.

### Advantageous Effects of Invention

In a current collector for a non-aqueous electrolyte secondary battery according to the invention, protrusions are formed on a surface of a metal foil in a predetermined arrangement, and each of the protrusions, when viewed from the direction perpendicular to the surface of the metal foil, has such a shape that both end portions in each of two orthogonal axial directions protrude outward while middle portions between the end portions that are adjacent in the circumferential direction of the protrusion are recessed inward. By forming a large number of protrusions on the current collector, the flexibility is improved. Also, when a compression process is applied to the current collector after the active material layer is formed on the surface of the current collector, it is possible to prevent the current collector from having problems such as becoming wavy, wrinkled, or warped.

Also, when an active material is deposited in a columnar shape on the protrusions by, for example, vapor deposition to form columnar blocks of the active material which serve as an active material layer as a whole, the cross-sectional shape of the columnar blocks also becomes similar to that of the protrusions.

At this time, by aligning the protrusions in a zigzag in such a manner that the two axial directions of the protrusions agree with the longitudinal direction and lateral direction of the zigzag alignment, it is possible to increase the gaps between the columnar blocks in the direction in which the interval between the adjacent columnar blocks is the smallest (the direction in which the protrusions are aligned slantwise in the zigzag alignment). It is thus possible to alleviate the compressive stress created by contact of the columnar blocks due to expansion of the active material upon charging the non-aqueous electrolyte secondary battery. As a result, it is possible to suppress the current collector from becoming wrinkled or the active material layer from falling off the electrode.

Therefore, the use of the current collector for a non-aqueous electrolyte secondary battery according to the invention can provide an electrode for a non-aqueous electrolyte secondary battery and a non-aqueous electrolyte secondary battery in which performance deterioration due to charge/discharge cycles is small and the reliability is high.

Also, in a current collector for a non-aqueous electrolyte secondary battery according to the invention, a plurality of protrusions are formed on at least one face of a metal foil, and a plurality of projections are formed on the top face of each protrusion. By forming a plurality of projections on the top face of each protrusion, the adhesion between the current collector and the active material layer can be increased. As a result, fall-off of the active material layer during charge/discharge can be suppressed.

Therefore, the use of the current collector for a non-aqueous electrolyte secondary battery according to the invention can provide an electrode for a non-aqueous electrolyte secondary battery and a non-aqueous electrolyte secondary battery in which performance deterioration due to charge/discharge cycles is smaller and the reliability is higher.

Also, in an electrode for a non-aqueous electrolyte secondary battery according to the invention, a current collector comprises a metal foil and a plurality of protrusions formed on both faces of the metal foil in a predetermined arrangement, and an active material layer is formed on each face of the current collector. The active material layer comprises a group of columnar blocks of an active material formed on the protrusions, and the thickness of the active material layer on one face of the current collector is greater than the thickness of the active material layer on the other face.

Thus, even when there is variation in the amount of active material carried on the current collector, the negative electrode is prevented from becoming wavy, for example, upon supplementation of lithium to the negative electrode active material.

Also, when the electrode is, for example, wound to form an electrode assembly, the electrode is wound in such a manner that the thinner active material layer is positioned on the inner side while the thicker active material layer is positioned on the outer side. As a result, it is possible to alleviate the compression stress exerted on the active material on the inner side which expands more significantly during lithium supplementation or charge.

Therefore, the use of the current collector for a non-aqueous electrolyte secondary battery according to the invention can provide an electrode for a non-aqueous electrolyte secondary battery and a non-aqueous electrolyte secondary battery in which performance deterioration due to charge/discharge cycles is smaller and the reliability is higher.

### BRIEF DESCRIPTION OF DRAWINGS

FIG. 1 is a plan view schematically showing the structure of a current collector for a non-aqueous electrolyte secondary battery according to Embodiment 1 of the invention;

FIG. 2 is an enlarged perspective view of a part of the current collector;

FIG. 3 is a perspective view showing a part of a production device for producing the current collector;

FIG. 4 is an enlarged perspective view of a part of a roller used in the production device;

FIG. 5A is a sectional view showing a step of the process for producing the current collector using the production device;

FIG. 5B is a sectional view showing another step of the process;

FIG. 6 is a sectional view showing still another step of the process;

FIG. 7 is an enlarged perspective view schematically showing the structure of a part of a current collector for a non-aqueous electrolyte secondary battery according to Embodiment 2 of the invention;

FIG. 8 is an enlarged perspective view schematically showing the structure of a part of a current collector for a non-aqueous electrolyte secondary battery according to Embodiment 3 of the invention;

FIG. 9 is an enlarged sectional view schematically showing the structure of a part of a current collector for a non-aqueous electrolyte secondary battery according to Embodiment 4 of the invention;

FIG. 10 is an enlarged sectional view schematically showing the structure of a part of a current collector for a non-aqueous electrolyte secondary battery according to Embodiment 5 of the invention;

FIG. 11 is a sectional view schematically showing the structure of a non-aqueous electrolyte secondary battery using the current collector for a non-aqueous electrolyte secondary battery according to the above embodiments;

FIG. 12 is an enlarged perspective view schematically showing the structure of a part of a current collector for a non-aqueous electrolyte secondary battery according to Embodiment 6 of the invention;

FIG. 13 is an enlarged perspective view of a part of an exemplary roller used for producing the current collector;

FIG. 14 is an enlarged perspective view of a part of another exemplary roller used for producing the current collector;

FIG. 15 is a perspective view schematically showing the structure of a production device including the rollers used for producing the current collector;

FIG. 16 is a perspective view showing an exemplary current collector with projections that are formed on the surface by the production device;

FIG. 17 is a perspective view showing another exemplary current collector with projections that are formed on the surface by the production device;

FIG. 18 is a sectional view schematically showing the structure of a current collector for a non-aqueous electrolyte secondary battery according to Embodiment 7 of the invention;

FIG. 19 is a sectional view schematically showing the structure of a part of a device for producing the current collector;

FIG. 20 is a sectional view of a part of a non-aqueous electrolyte secondary battery using the current collector;

FIG. 21 is a sectional view schematically showing the structure of a current collector for a non-aqueous electrolyte secondary battery according to Embodiment 8 of the invention;

FIG. 22 is a schematic view showing an exemplary evaluation method in an Example according to Embodiments 7 and 8;

FIG. 23 is a schematic view showing another exemplary evaluation method in the Example according to Embodiments 7 and 8;

FIG. 24 is a schematic view showing still another exemplary evaluation method in the Example according to Embodiments 7 and 8; and

FIG. 25 is a sectional view showing an example of a conventional current collector for a non-aqueous electrolyte secondary battery.

### DESCRIPTION OF EMBODIMENTS

Embodiments of the invention are hereinafter described with reference to drawings.

### Embodiment 1

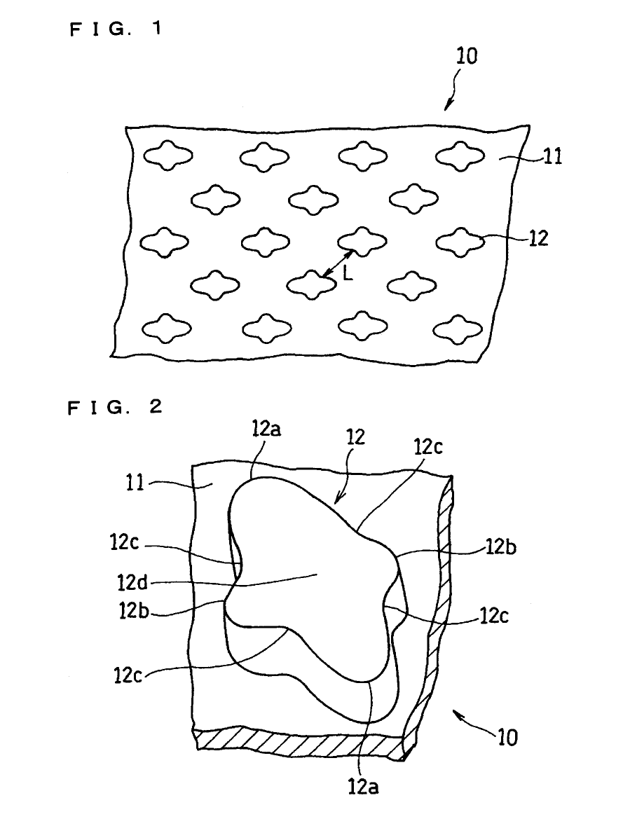

FIG. 1 is a plan view schematically showing the structure of a current collector for a non-aqueous electrolyte secondary battery according to Embodiment 1 of the invention. FIG. 2 is an enlarged perspective view of a part thereof.

A current collector 10 illustrated therein includes a metal foil 11 shaped like a long strip and a large number of protrusions 12 formed on at least one face of the metal foil 11 in a predetermined arrangement.

As illustrated in FIG. 2, the protrusion 12 is substantially rhombic in a plan view. More specifically, when the protrusion 12 is viewed from the direction perpendicular to the surface of the metal foil 11, the protrusion 12 has end portions 12a in the major axis direction (hereinafter referred to as major axis end portions) and end portions 12b in the minor axis direction (hereinafter referred to as minor axis end portions), and these end portions 12a and 12b are curved so as to protrude outward. Also, the protrusion 12 has middle portions 12c between the major axis end portions 12a and the minor axis end portions 12b, and the middle portions 12c are curved so as to be recessed inward.

The protrusions 12 are preferably aligned in a zigzag as illustrated in FIG. 1. In this alignment, the protrusions 12 are preferably oriented so that the minor axis direction and the major axis direction agree with the longitudinal direction and lateral direction of the zigzag alignment, respectively. At this time, all the intervals between the protrusions 12 aligned slantwise are preferably equal.

Therein, the smallest interval between the adjacent protrusions 12 is the interval L between the protrusions 12 aligned slantwise.

The protrusions 12 are formed to form columnar blocks 20 of an active material thereon, and the columnar blocks 20 are mainly formed by depositing the active material into a columnar shape by a vacuum process such as vapor deposition, as illustrated in FIG. 6 which will be described below. By providing the protrusions 12 in a suitable alignment such as the zigzag alignment, it is possible to form an active material thin film composed of a large number of the columnar blocks 20 on a surface of the current collector 10. The thin film constitutes an active material layer 21.

By forming the protrusions 12 in such a manner that the middle portions 12c between the major axis end portions 12a and the minor axis end portions 12b are curved so as to be recessed, the interval L can be increased.

Hence, when the columnar blocks 20 of active material are formed on the protrusions 12, the portions of the columnar blocks 20 corresponding to the middle portions 12c of the protrusions 12 are also curved so as to be recessed in a cross section.

As a result, the side faces of the columnar blocks 20 are recessed at the portions where the interval between the adjacent columnar blocks 20 is the smallest, and a gap 23 between the adjacent columnar blocks 20 can be increased.

As such, when the expansion and contraction of the active material due to charge/discharge of the non-aqueous electrolyte secondary battery cause the columnar blocks 20 to come into contact with one another to create a compressive stress therebetween, the occurrence of a stress can be suppressed at portions where the stress is otherwise the largest. As a result, it is possible to suppress occurrence of wrinkles in the current collector 10 and fall-off of the active material layer from the current collector 10 while minimizing the amount of volume loss of the columnar blocks 20, i.e., maximizing the amount of active material supported on the current collector 10.

Also, a top face 12d of each protrusion 12 has such a curved shape that the height decreases from the center toward the edge. Since the top face 12d of the protrusion 12 has such a shape, the top face 12d of the protrusion 12 can hold the largest amount of active material when the active material layer 21 is formed by, for example, vapor deposition. Hence, the gaps 23 between the adjacent columnar blocks 20 can be increased. It is thus possible to alleviate the internal stress of the active material layer created by contact of the columnar blocks 20 due to expansion and contraction of the active material during charge/discharge.

Also, it is preferable to form the protrusions 12 by applying a compression process to the metal foil 11 in such a manner that the surface roughness of each top face 12d maintains the surface roughness of the metal foil 11 of which the top face 12d is made. This makes it possible to further increase the adhesion between the top face 12d and the columnar block 20 formed on the protrusion 12.

Also, since the top faces 12d of the protrusions 12 maintain the surface roughness of the metal foil 11 before the compression process, the durability of the current collector 10 is improved. It is thus possible to prevent the current collector 10 from becoming partially deformed or distorted in the process of forming the protrusions 12 on the surface of the current collector 10 or the process of disposing the active material on the current collector 10.

Further, the protrusions 12 have such a shape that they are wide at the base and tapered toward the top. Hence, when the protrusions 12 are formed by a compression process as described below, the protrusions 12 can be smoothly released from a die (i.e., the protrusions 12 can be smoothly pulled out from depressions 22 formed in the surface of a roller 16 or 18).

Also, due to such a shape of the protrusions 12, the width of the top face 12d of each protrusion 12 is smaller than that of the cross-section of the base of the protrusion 12, thereby allowing the columnar block 20 to be tapered toward the top. Hence, the gaps between the adjacent columnar blocks 20 can be increased. It is thus possible to alleviate the stress created by expansion and contraction of the active material during charge/discharge.

Also, since the side face of each middle portion 12c of the protrusion 12 is also slanted in such a manner that it is gradually recessed inward toward the top, the side face of the columnar block 20 corresponding to the middle portion 12c can be recessed more reliably. As a result, the above-mentioned effect can be achieved more reliably.

The method of forming the protrusions 12 is described below.

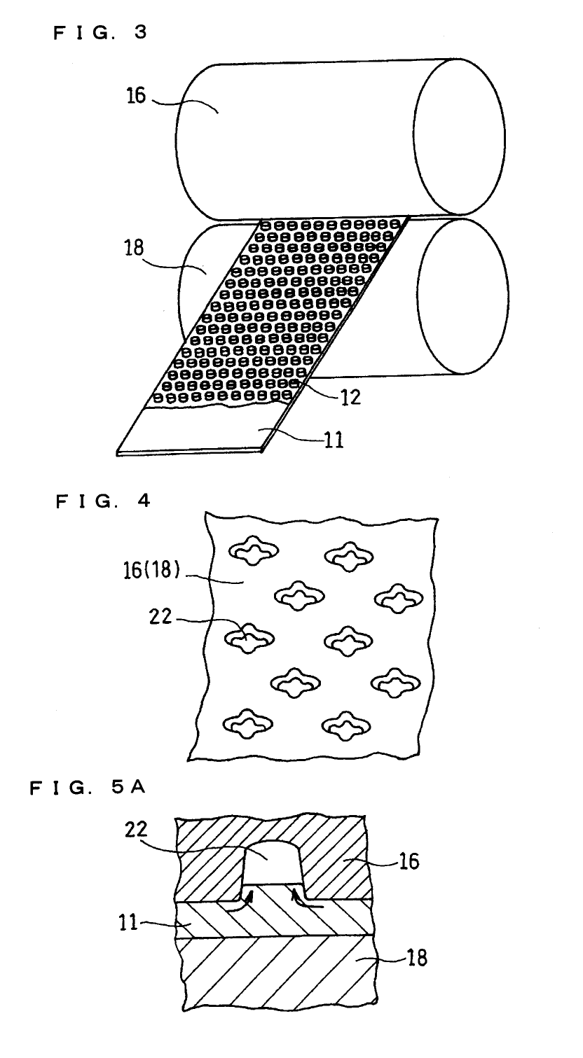

As illustrated in FIG. 3, the protrusions 12 can be formed by applying a compression process to the metal foil 11 using a pair of upper and lower rollers 16 and 18. In FIG. 4, the shape of the protrusions 12 is simplified in consideration of visibility.

In the case of forming the protrusions 12 on both faces of the metal foil 11, the upper and lower rollers 16 and 18 are provided with the depressions 22 having a shape corresponding to that of the protrusions 12 in an arrangement corresponding to that of the protrusions 12, as illustrated in FIG. 4. Using these rollers 16 and 18, the metal foil 11 is subjected to a compression process.

In the case of forming the protrusions 12 on only one face of the metal foil 11, for example, only the upper roller 16 is provided with the depressions 22, while the surface of the lower roller 18 is left flat. Using these rollers 16 and 18, the metal foil 11 is subjected to a compression process. The method for forming the protrusions 12 is not limited to the method using rollers, and the protrusions 12 can also be formed by using, for example, dies, i.e., sandwiching the metal foil 11 between an upper die and a lower die and applying a compression process thereto.

With respect to the material of the rollers 16 and 18, the surface of a metal roller is preferably coated with a ceramic such as CrO (chromium oxide), WC (tungsten carbide), or TiN (titanium nitride). In this case, the depressions 22 are formed on the coating. They can be preferably formed by laser machining. In addition, the depressions 22 can be formed by a process such as etching, dry etching, or blasting.

Also, the shape of the depressions 22 can be varied depending on the shape of the protrusions 12 that are intended to be formed. For example, the shape of the depressions 22 is a substantial rectangle, a substantial square, or a substantially regular hexagon.

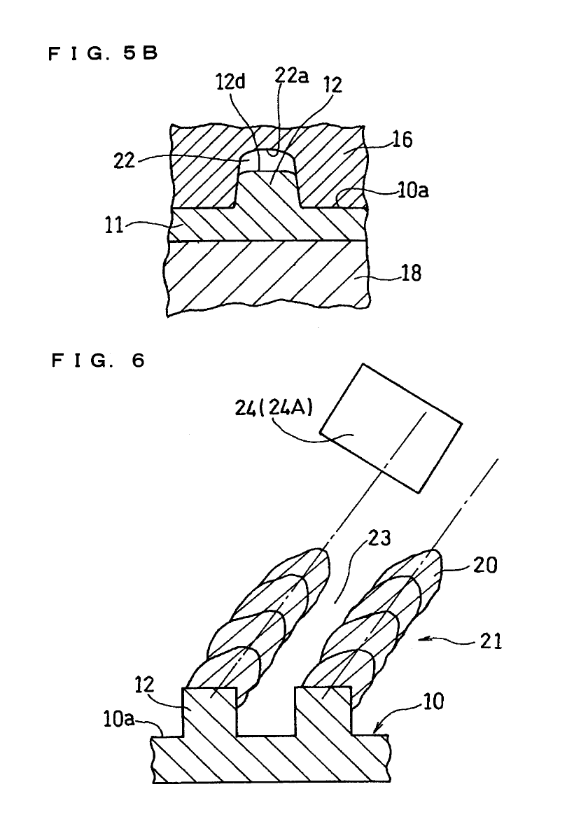

FIGS. 5A and 5B show a sequence of steps for forming protrusions by a compression process using rollers. A description is given below of steps for forming the protrusions 12 on only one face of the metal foil 11 using the upper roller 16 with the depressions 22 and the lower roller 18 with a flat surface. In FIGS. 5A and 5B, the shape of the protrusions 12 and the depressions 22 is simplified in consideration of visibility.

As illustrated in FIG. 5A, when the metal foil 11 is passed between the upper roller 16 and the lower roller 18 which are placed with a predetermined gap therebetween, the metal foil 11 is compressed so that its thickness decreases. As a result, plastic deformation starts to occur in such a manner that the constituent metal of the metal foil 11 moves into the depression 22 along the side face of the depression 22, as shown by the arrows in the figure.

As illustrated in FIG. 5B, when the metal foil 11 is further compressed, the protrusion 12 is formed by the constituent metal of the metal foil 11 having moved into the depression 22 by plastic deformation. At this time, the top face 12d of the protrusion 12 curves in such a manner that it protrudes slightly in the middle due to plastic deformation, as described above.

Also, the depth of the depression 22 is set so that there is a space between the top face 12d of the protrusion 12 and a bottom face 22a of the depression 22. As a result, the surface roughness of the top face 12d of the protrusion 12 maintains the surface roughness of the metal foil 11. However, the surface of the metal foil 11 compressed by the portion of the upper roller 16 excluding the depression 22 has a decreased surface roughness because it is flattened by the compression. In this manner, a base plane 10a with a smaller surface roughness than the top face 12d of the protrusion 12 is formed.

As described above, in the current collector 10, since the surface roughness of the top face 12d of the protrusion 12 is larger than that of the base plane 10a, the adhesion of an active material to the top face 12d of the protrusion 12 can be increased.

Also, since a large number of the protrusions 12 are formed on the surface of the current collector 10, stretching of the current collector 10 or occurrence of local stress can be suppressed. As a result, it is possible to suppress the current collector 10 from having problems such as becoming wavy, wrinkled, or warped. It is also possible to increase the strength of the current collector 10.

Also, the depressions 22 are tapered in such a manner that the width of the depressions 22 decreases in the depth direction, in order to improve the workability of the protrusions 12 and increase the ease with which the protrusions 12 are released from the depressions 22. This taper corresponds to the above-mentioned taper of the protrusions 12.

Next, a description is given of an electrode for a non-aqueous electrolyte secondary battery which is produced by disposing a positive electrode active material or negative electrode active material on the current collector 10.

First, a description is given of a case in which an active material layer is formed on the current collector 10 by an application method to produce an electrode for a non-aqueous electrolyte secondary battery.

When the electrode is a positive electrode, foil or non-woven fabric made of aluminum or an aluminum alloy can be used as the material of the positive electrode current collector. Its thickness can be made 5 μm to 30 μm. A positive electrode is produced by applying a positive electrode mixture slurry onto one face or both faces of a positive electrode current collector with a die coater, drying it, and rolling it with a press until the whole thickness reaches a predetermined thickness. The positive electrode mixture slurry is produced by mixing and dispersing a positive electrode active material, a positive electrode conductive agent, and a positive electrode binder in a dispersion medium with a dispersing device such as a planetary mixer.

Examples of positive electrode active materials which can be used include lithium-containing transition metal oxides such as lithium cobaltate and modified lithium cobaltate (lithium cobaltate solid solutions with aluminum or magnesium dissolved therein), lithium nickelate and modified lithium nickelate (those in which a part of the nickel is replaced with cobalt), and lithium manganate and modified lithium manganate.

Examples of positive electrode conductive agents which can be used include carbon blacks such as acetylene black, ketjen black, channel black, furnace black, lamp black, and thermal black and various graphites, and they can be used singly or in combination.

Examples of positive electrode binders which can be used include polyvinylidene fluoride (PVdF), modified polyvinylidene fluoride, polytetrafluoroethylene (PTFE), and rubber particles having an acrylate unit. Such a binder can also include an acrylate monomer or acrylate oligomer with a reactive functional group introduced therein.

When the electrode is a negative electrode, for example, rolled copper foil or electrolytic copper foil can be used as the material of the negative electrode current collector. Its thickness can be made 5 μm to 25 μm. A negative electrode is produced by applying a negative electrode mixture slurry onto one face or both faces of a negative electrode current collector with a die coater, drying it, and rolling it with a press until the whole thickness reaches a predetermined thickness. The negative electrode mixture slurry is prepared by mixing and dispersing a negative electrode active material, a negative electrode binder, and if necessary, a negative electrode conductive agent and a thickener in a dispersion medium with a dispersing device such as a planetary mixer.

Preferable examples of negative electrode active materials which can be used include carbon materials such as graphite and alloyable materials. Examples of alloyable materials which can be used include silicon oxides, silicon, silicon alloys, tin oxides, tin, and tin alloys. Among them, silicon oxides are particularly preferable. Desirable silicon oxides are represented by the general formula SiOₓ where 0<x<2, preferably 0.01≦×≦1. In a silicon alloy, the other metal element than silicon is desirably a metal element which is not alloyable with lithium, such as titanium, copper, or nickel.

As the negative electrode binder, various binders such as PVdF and modified PVdF can be used. In terms of enhancing lithium ion acceptance, styrene-butadiene copolymer rubber particles (SBR) and modified SBR can also be used.

The thickener is not particularly limited and can be a viscous material as an aqueous solution, such as polyethylene oxide (PEO) or polyvinyl alcohol (PVA). However, it is preferable to use cellulose resins such as carboxymethyl cellulose (CMC) and modified cellulose resins in terms of the dispersibility and viscosity of the electrode mixture slurry.

Next, a method of disposing an active material on the current collector 10 by a vacuum process is described. A vacuum process allows an active material to be selectively disposed on a specific portion of the current collector 10.

In this case, it is preferable to deposit an active material on the top face 12d of each protrusion 12 in a columnar form. When an active material layer is formed of the columnar blocks 20 of an active material, this is expected to reduce the adverse effect of the volume expansion of the active material upon lithium absorption.

Further, since the top faces 12d of the protrusions 12 are not compressed, the initial surface accuracy can be maintained without being affected by work strain or the like. As a result, when an active material is deposited on the top faces 12d of the protrusions 12 to form an active material layer, the amount of the active material contained therein and the thickness of the layer can be controlled with good accuracy.

The vacuum process is not particularly limited, and a dry process such as vapor deposition, sputtering, or CVD can be used. Examples of negative electrode active materials which can be used therein include simple substances of Si, Sn, Ge (germanium), and Al (aluminum), alloys thereof, oxides such as SiOₓ (silicon oxides) and SnOₓ (tin oxides), and sulfides such as SiSₓ (silicon sulfide) and SnS (tin sulfide). They are preferably amorphous or low-crystalline.

While the thickness of the active material layer changes according to the characteristics the non-aqueous electrolyte secondary battery to be produced is required to provide, it is preferably in the range of 5 to 30 μm, and more preferably in the range of 10 to 25 μm.

FIG. 6 shows how a negative electrode active material is deposited on protrusions. As illustrated therein, while oxygen (not shown) is supplied to the vicinity of the protrusions 12 on the current collector 10, a deposition source 24, where a Si containing raw material for active material is disposed, is heated with an electron beam (not shown) to deposit the raw material for active material on the protrusions 12 by evaporation. At this time, the positional relation between the deposition source 24 and the current collector 10 is set so that the evaporated raw material for active material is deposited from the direction parallel to the sheet of FIG. 6 slantwise with respect to the surface (or base plane 10a) of the current collector 10.

As a result, the slanting columnar blocks 20 are formed as illustrated in FIG. 6. A group of these columnar blocks 20 constitute the active material layer 21. It should be noted that the vertical direction in FIG. 1 (the longitudinal direction of the current collector 10) agrees with the horizontal direction in FIG. 6.

Also, as illustrated in FIG. 6, after the active material layer is formed, another deposition source 24A, which produces lithium vapor, is disposed at a predetermined position. At this time, the orientation of the deposition source 24A is set in line with the slant of the central axes of the columnar blocks 20. Thus, the traveling direction of the lithium vapor agrees with the direction of the central axes of the columnar blocks 20. As a result, it is possible to selectively deposit lithium on the columnar blocks 20 and suppress the lithium vapor from being deposited on the base plane 10a of the current collector 10.

The method of forming the active material layer is not limited to the one described above; for example, the columnar blocks can be formed so that their central axes are perpendicular to the base plane 10a. Also, the columnar blocks 20 can be formed so that they each consists of several layers (four layers in the illustrated example), as illustrated in FIG. 6. In this case, the columnar blocks can be staggered by slanting the central axes in the first layer at a predetermined angle and slanting the central axes in the second layer in a different direction.

### Embodiment 2

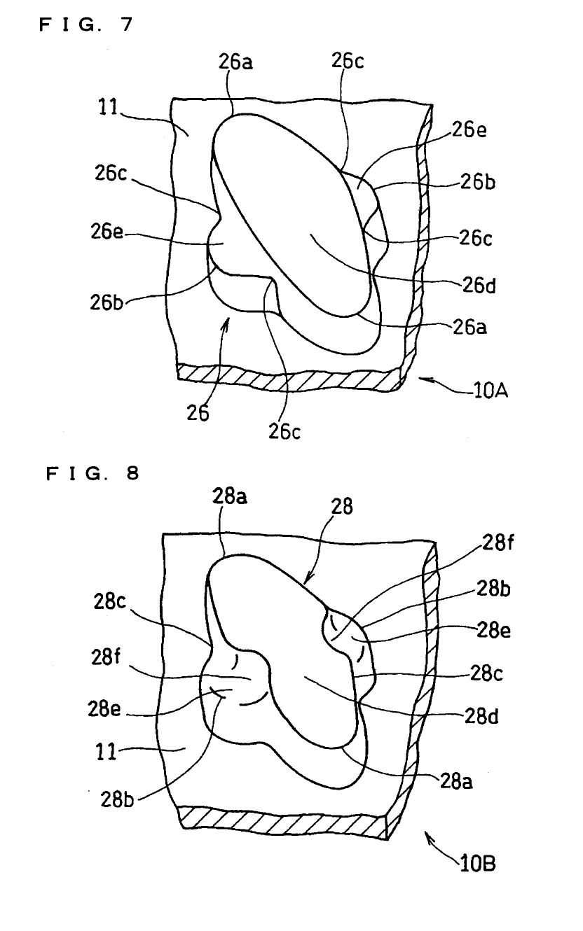

Next, Embodiment 2 of the invention is described. FIG. 7 is an enlarged perspective view of a part of a current collector according to Embodiment 2 of the invention.

A current collector 10A illustrated in FIG. 7 has a protrusion 26, and major axis end portions 26a and minor axis end portions 26b are curved so as to protrude outward, while middle portions 26c between the major axis end portions 26a and the minor axis end portions 26b are curved so as to be recessed inward, just like the current collector 10 illustrated in FIG. 2.

The current collector 10A of FIG. 7 is different from the current collector 10 of FIG. 2 in that the major axis end portions 26a of the protrusion 26 are higher than the minor axis end portions 26b.

Between the two major axis end portions 26a is a main top face 26d, which is as high as or higher than the end portions 26a. On both sides of the main top face 26d are sub-top faces 26e, which correspond to the two minor axis end portions 26b, respectively. The main top face 26d is highest at the center and becomes gradually lower toward the edge.

By forming the protrusion 26 in such a manner that the major axis end portions 26a and the minor axis end portions 26b have different heights, the shape of the top face of the protrusion 26 can be changed so that the columnar block 20 of active material can be held on the protrusion 26 more firmly. It is thus possible to suppress fall-off of the active material layer from the current collector 10 more reliably.

### Embodiment 3

Next, Embodiment 3 of the invention is described. FIG. 8 is an enlarged perspective view of a part of a current collector according to Embodiment 3 of the invention.

A current collector 10B illustrated in FIG. 8 has a protrusion 28, and major axis end portions 28a and minor axis end portions 28b are curved so as to protrude outward, while middle portions 28c between the major axis end portions 28a and the minor axis end portions 28b are curved so as to be recessed inward, just like the current collector 10A illustrated in FIG. 7. Also, the major axis end portions 28a are higher than the minor axis end portions 28b. Between the two major axis end portions 28a is a main top face 28d, which is as high as or higher than the end portions 28a. On both sides of the main top face 26d are sub-top faces 26e, which correspond to the two minor axis end portions 26b, respectively.

The current collector 10B of FIG. 8 is different from the current collector 10A of FIG. 7 in that the protrusion 28 has indentations 28f adjacent to the sub-top faces 26e on both sides of the main top face 28d. The indentations 28f are at least partially spherical.

By forming the indentations 28f on both sides of the main top face 28d, the side faces of the columnar block 20 of active material formed on the protrusion 28 are also recessed in the same manner. As a result, the gaps 23 between the adjacent columnar blocks 20 can be increased. It is thus possible to alleviate the compressive stress created by contact of the columnar blocks of active material due to expansion and contraction of the electrode active material when the non-aqueous electrolyte secondary battery is charged/discharged.

### Embodiment 4

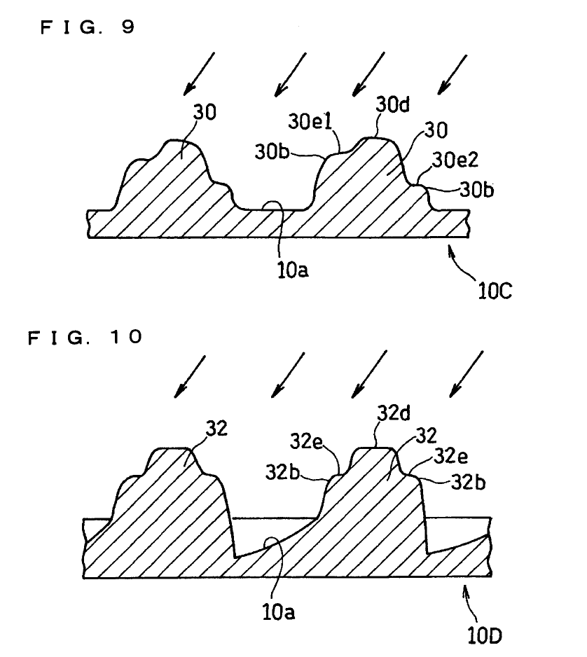

Next, Embodiment 4 of the invention is described. FIG. 9 illustrates a part of a current collector according to Embodiment 4 of the invention.

In a current collector 10C illustrated in FIG. 9, a protrusion 30 basically has the same shape as the protrusion 26 of the current collector 10A illustrated in FIG. 7. The current collector 10C is different from the current collector 10A of FIG. 7 in that minor axis end portions 30b of the protrusion 30 have different heights.

Since the minor axis end portions 30b have different heights, when the vapor of a raw material for active material is deposited slantwise with respect to the surface of the current collector 10C to form the active material layer 21 as shown by the arrows in the figure, a sub-top face 30e1, which is higher than a sub-top face 30e2, prevents the vapor of the raw material for active material from reaching the base plane 10a between the protrusions 30 which is in the shadow of the sub-top face 30e1. As a result, the gaps 23 can be formed between the columnar blocks 20 formed on the protrusions 30 more reliably.

It is thus possible to alleviate the compressive stress created in the active material layer due to expansion and contraction of the active material when the non-aqueous electrolyte secondary battery is charged/discharged.

### Embodiment 5

Next, Embodiment 5 of the invention is described. FIG. 10 illustrates a part of a current collector according to Embodiment 5 of the invention.

In a current collector 10D illustrated in FIG. 10, a protrusion 32 has the same shape as the protrusion 26 of the current collector 10A illustrated in FIG. 7. The current collector 10D is different from the current collector 10B of FIG. 7 in that the base plane 10a is slanted between the adjacent two protrusions 32.

By slanting the base plane 10a between the protrusions 32, when an active material is deposited slantwise with respect to the surface of the current collector 10D as shown by the arrows in the figure, the active material is unlikely to be deposited on the base plane 10a between the protrusions 32. As a result, gaps can be formed between the columnar blocks 20 formed on the protrusions 32 more reliably.

It is thus possible to alleviate the compressive stress created in the active material layer due to expansion and contraction of the active material when the non-aqueous electrolyte secondary battery is charged/discharged.

Next, non-aqueous electrolyte secondary batteries using the current collectors of Embodiments 1 to 5 for non-aqueous electrolyte secondary batteries are described.

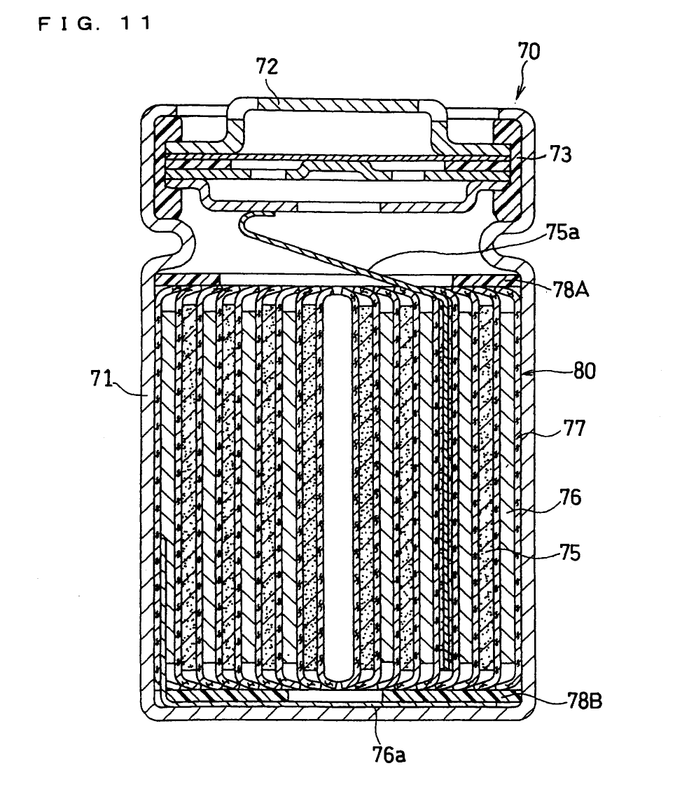

FIG. 11 illustrates an example of such non-aqueous electrolyte secondary batteries. A secondary battery 70 illustrated therein includes an electrode assembly 80 which is produced by spirally winding a positive electrode 75 comprising positive electrode active material layers formed on a positive electrode current collector and a negative electrode 76 comprising negative electrode active material layers formed on a negative electrode current collector, with a separator 77 interposed therebetween. Also, a positive electrode lead 75a is attached to the positive electrode 75, while a negative electrode lead 76a is attached to the negative electrode 76.

The electrode assembly 80, fitted with upper and lower insulator plates 78A and 78B, are placed in a cylindrical battery case 71 with a bottom. The negative electrode lead 76a drawn from the lower part of the electrode assembly 80 is connected to the bottom of the battery case 71. The positive electrode lead 75a drawn from the upper part of the electrode assembly 80 is connected to a seal member 72, which seals the opening of the battery case 71. Also, a predetermined amount of a non-aqueous electrolyte (not shown) is injected into the battery case 71. The injection of the non-aqueous electrolyte is made after the electrode assembly 80 is placed in the battery case 71. After the completion of injection of the non-aqueous electrolyte, the seal member 72, around which a sealing gasket 73 is fitted, is inserted into the opening of the battery case 71, and the opening of the battery case 71 is crimped inward to provide the lithium ion secondary battery 70.

The separator 77 is not particularly limited if it has a composition capable of use as a separator for a non-aqueous electrolyte secondary battery. However, it is common and preferable as an embodiment to use one or more microporous films made of olefin resin such as polyethylene or polypropylene. While the thickness of the separator 77 is not particularly limited, it can be set to 10 to 25 μm.

With respect to the non-aqueous electrolyte, various lithium compounds such as LiPF₆ and LiBF₄ can be used as electrolyte salts. Also, as the solvent, ethylene carbonate (EC), dimethyl carbonate (DMC), diethyl carbonate (DEC), and methyl ethyl carbonate (MEC) can be used singly or in combination. It is also preferable to add vinylene carbonate (VC), cyclohexyl benzene (CHB), modified VC, or modified CHB to the non-aqueous electrolyte in order to form a good coating film on the surface of the positive electrode 75 or negative electrode 76, or ensure stability upon overcharge.

Next, Examples according to Embodiments 1 to 5 are described. The invention is not to be construed as being limited to these Examples.

### Example 1

A lithium ion secondary battery was produced as follows.

A 15-μm thick aluminum foil was prepared as a material of a positive electrode current collector. This aluminum foil was subjected to a compression process using a pair of rollers with 4-μm deep depressions formed in the surface in a zigzag, so that 3-μm high protrusions with the shape as illustrated in FIG. 2 were formed on both faces of the aluminum foil in a zigzag. A positive electrode current collector with a total thickness of 18 μm was produced in this manner.

The protrusions had a length of 17 μm in the major axis direction and a length of 10 μm in the minor axis direction. The rollers used for the compression process were made of a metal, namely, a superhard material. Their surfaces were coated with a ceramic, namely, chromium oxide.

Lithium cobaltate in which part of the cobalt was replaced with nickel and manganese was used as a positive electrode active material. A positive electrode mixture slurry was prepared by stirring and kneading 100 parts by weight of the positive electrode active material, 2 parts by weight of acetylene black serving as a conductive agent, 2 parts by weight of polyvinylidene fluoride as a binder, and a suitable amount of N-methyl-2-pyrrolidone with a double-arm kneader. This positive electrode mixture slurry was applied onto both faces of the positive electrode current collector and dried to form a 85-μm thick active material layer on each face of the positive electrode current collector. The positive electrode current collector was pressed to a total thickness of 146 μm to obtain a positive electrode precursor with a 64.0-μm thick active material layer on each face. This was slit to a predetermined width to produce a positive electrode.

A 26-μm thick copper foil was prepared as a material of a negative electrode current collector. This copper foil was subjected to a compression process using a pair of rollers with 10-μm deep depressions formed in the surface in a zigzag, so that 8-μm high protrusions with the shape as illustrated in FIG. 2 were formed on both faces of the copper foil in a zigzag. A negative electrode current collector with a total thickness of 26 μm was produced in this manner. The protrusions had a length of 17 μm in the major axis direction and a length of 10 μm in the minor axis direction. The rollers used for the compression process were made of the same material as that used to produce the positive electrode current collector and were coated with the same material.

Negative electrode active material layers were formed on the negative electrode current collector as follows.

Si with a purity of 99.9999% was heated with an electron beam and deposited on both faces of the negative electrode current collector while oxygen with a purity of 99.7% was being supplied. The deposition was performed in four operations. In each of the four operations, the direction of deposition was set so that columnar blocks grew on the protrusions in the same direction. In this manner, a 23-μm thick active material layer comprising SiO_{0.5} was formed on each surface of the negative electrode current collector.

Thereafter, using lithium as a deposition material, lithium was deposited on the active material layers by allowing the traveling direction of lithium vapor from the deposition source to agree with the growth direction of the columnar blocks. Thereafter, this was slit to a predetermined width to produce a negative electrode.

Next, the positive electrode and the negative electrode were spirally wound with a separator interposed therebetween, to produce an electrode assembly. Using the produced electrode assembly, a lithium ion secondary battery as illustrated in FIG. 11 was produced.

In the lithium ion secondary battery thus produced, since the positive electrode current collector and the negative electrode current collector were provided with the protrusions in the predetermined arrangement, the current collectors had a sufficient ability to withstand the tensile stress exerted in the longitudinal direction. Therefore, it was possible to prevent the positive electrode current collector from becoming partially deformed or distorted when the positive electrode active material layers were formed on the positive electrode current collector to produce the positive electrode, or when the positive electrode was slit to the predetermined width. It was also possible to suppress fall-off of the positive electrode active material layers.

Also, the negative electrode could be handled safely, since there was no lithium adhering to or deposited on the portions between the protrusions of the negative electrode current collector and there was also no hydrogen production due to the absence of lithium which reacts with moisture in the air. In addition, since gaps were formed between the protrusions of the negative electrode current collector, even when the negative electrode active material expanded due to absorption of lithium ions during charge, it was possible to prevent occurrence of excessive compressive stress inside the active material layers. As a result, the stress exerted to the negative electrode current collector during charge could be reduced.

Also, after the electrode assembly was produced, it was disassembled again for observation. As a result, both positive and negative electrodes were found to have no problem such as breakage of the electrode plate or fall-off of the active material.

Further, the lithium ion secondary battery produced in the above manner was subjected to 300 charge/discharge cycles. At this time, in a 20° C. environment, it was charged to 4.2 V at a constant current of 0.7 C, charged to a cut-off voltage of 0.05 C at a constant voltage, and discharged to 2.5 V at a constant current of 0.2 C. The discharge capacity obtained was used as the initial discharge capacity. Thereafter, with the discharge current value set to 1 C, the charge/discharge cycle was repeated.

However, the battery performance did not deteriorate significantly. In this state, the electrode assembly was disassembled, and was found to have no problem such as deposition of lithium metal and fall-off of the active material layers.

This is probably because the active material layer, in particular, the negative electrode active material layer, was composed of a group of columnar blocks formed on the protrusions of the negative electrode current collector, thereby making it possible to alleviate the stress created by expansion and contraction of the negative electrode active material due to charge/discharge and to suppress fall-off and the like of the negative electrode active material layers.

In Example 1, the current collectors used for both positive and negative electrodes had protrusions. However, it is also possible to use, for example, a current collector having no protrusions as a positive electrode current collector and form protrusions only on a negative electrode current collector. This can also achieve the above-mentioned effect since the degree of the expansion and contraction of the positive electrode active material is significantly smaller than that of the negative electrode active material.

### Embodiment 6

FIG. 12 is a perspective view schematically showing the structure of a current collector for a non-aqueous electrolyte secondary battery according to Embodiment 6 of the invention.

A current collector 10E illustrated therein has a plurality of protrusions 34 on at least one face, and the top face of each protrusion 34 has a plurality of minute projections 36.

Due to the plurality of minute projections 36 on the top face of each protrusion 34, the contact area between the active material and the current collector 10E is increased. This produces an anchor effect on the active material, thereby making it possible to further increase the adhesion at the interface between the current collector 10E and the active material layer.

Also, when an electrode using the current collector 10E is wound to form an electrode assembly, the strength of the electrode to withstand the bending stress can be increased. Thus, fall-off of the active material from the current collector 10E can be suppressed. It is thus possible to provide a highly safe electrode with good quality for non-aqueous electrolyte secondary batteries.

In the current collector 10E, the protrusions 34 are aligned in a row in the width direction of the long-strip like current collector 10E (the horizontal direction in the figure) at an equal pitch P1. The protrusions 34 aligned in a row is referred to as a row unit L1.

Further, in the current collector 10E, the row units L1 are aligned at an equal pitch P2 in the longitudinal direction of the current collector 10E (the vertical direction in the figure). Also, the protrusions 34 included in the adjacent row units L1 are displaced by ½ of the pitch P1 in the width direction of the current collector 10E. The distance displaced can be changed freely.

The height of the projections 36 formed on the top faces of the protrusions 34 is preferably 1 to 5 μm. If the height of the projections 36 is less than 1 μm, the contact area between the active material and the current collector 10E cannot be enlarged so much, and increasing the adhesion is difficult. On the other hand, if the height of the projections 36 exceeds 5 μm, the following problem occurs. For example, in the case of forming the projections 36 by a compression process using a roller, it is necessary to form depressions deeper than 5 μm in the surface of the roller. Since the diameter of the depressions is very small, if the depressions are formed by, for example, laser machining, the beam needs to be focused onto a small portion, and the depth of focus becomes shallow. It is thus difficult to form depressions deeper than 5 μm in the roller surface.

Also, the pitch of the projections 36 is preferably set to 1 to 5 μm. If the pitch of the projections 36 is made smaller than 1 μm, the diameter of the projections 36 themselves needs to be made very small. As a result, the strength of the projections 36 themselves becomes weak, and maintaining their shape is difficult. On the other hand, if the pitch of the projections 36 exceeds 5 μm, the density of the projections 36 becomes too low. Thus, the contact area between the active material and the current collector 10E cannot be enlarged so much, and increasing the adhesion is difficult.

As described above, by forming the minute projections 36 on the top faces of the protrusions 34, the strength of the electrode produced by using the current collector 10E to withstand the bending stress applied to the electrode assembly when wound can be increased. Also, since the adhesion between the current collector 10E and the active material is increased, fall-off of the active material layer can be suppressed, and it is possible to provide a safe electrode with high quality for non-aqueous electrolyte secondary batteries.

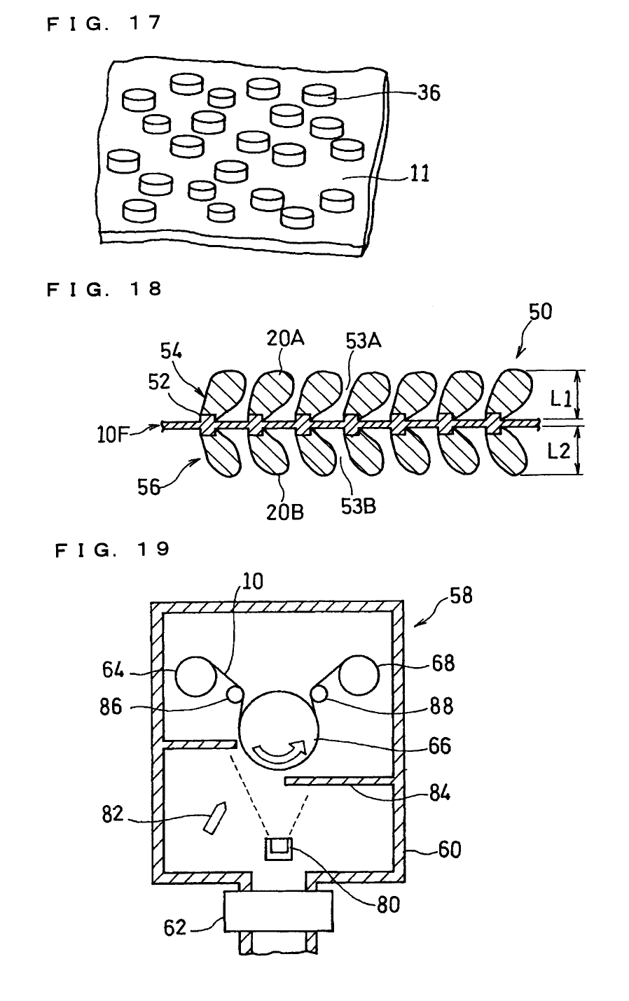

The arrangement of the projections 36 can be regular as shown in FIG. 16 below, or can be irregular as shown in FIG. 17 below.

FIG. 13 is an enlarged view of the surface of a roller that is suitable for forming the projections 36 in a regular arrangement by a compression process. The surface of a roller 38 has depressions 40 corresponding to the projections 36 in a regular arrangement. The arrangement of the depressions 40 are the same as that of the protrusions 34 illustrated in FIG. 12.

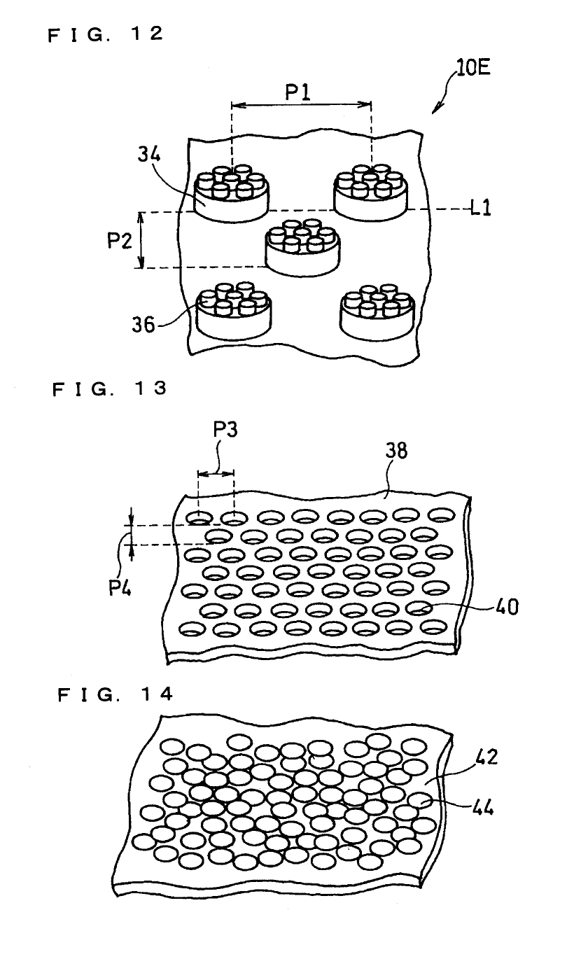

FIG. 14 is an enlarged view of the surface of a roller that is suitable for forming the projections 36 in an irregular arrangement by a compression process. The surface of a roller 42 has depressions 44 corresponding to the projections 36 in an irregular arrangement.

In the case of forming the depressions 44 in the surface of the roller 42 in an irregular arrangement as described above, it is preferable to form them by a process such as etching, dry etching, or blasting.

By making the arrangement of the projections 36 regular, the adhesion between the active material and the current collector 10E can be made uniform. It is thus possible to provide an electrode with stable quality for non-aqueous electrolyte secondary batteries.

On the other hand, by forming the projections 36 on the protrusions 34 in an irregular arrangement, even when a force is applied so as to cause the active material layer to separate or fall off, the force is difficult to propagate, and separation or fall-off of the active material layer can be suppressed. It is thus possible to provide a highly safe electrode with good quality for non-aqueous electrolyte secondary batteries.

Next, the procedure for forming protrusions and projections on a surface of a current collector by a compression process using rollers is specifically described.

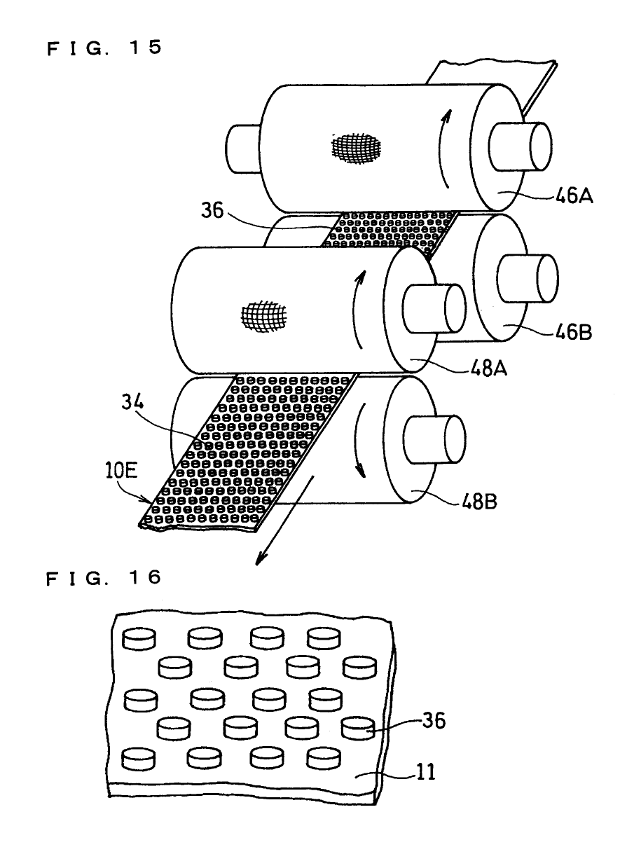

As illustrated in FIG. 15, in order to produce the current collector 10E with the protrusions 34 and the projections 36 formed on one face or both faces, it is preferable to apply a compression process to the metal foil 11 using two pairs of rollers 46A and 46B and 48A and 48B.

In the illustrated example, the pair of rollers 46A and 46B, at least one of which has the depressions 40 or 44 corresponding to the projections 36 in a surface, is disposed upstream of the transport direction of the metal foil 11 shown by the arrow in the figure. As a result, the minute projections 36 are formed on one face or both faces of the metal foil 11 in advance.

FIG. 16 illustrates the surface of the metal foil 11 immediately after being subjected to a compression process using the rollers 46A and 46B, at least one of which has the depressions 40 in a regular arrangement. The surface of the metal foil 11 has the projections 36 in a regular arrangement corresponding to that of the depressions 40 in FIG. 13.

FIG. 17 illustrates the surface of the metal foil 11 immediately after being subjected to a compression process using the rollers 46A and 46B, at least one of which has the depressions 44 in an irregular arrangement. The surface of the metal foil 11 has the projections 36 in an irregular arrangement corresponding to that of the depressions 44 in FIG. 14.

In FIG. 15, the pair of rollers 48A and 48B, at least one of which has the depressions 22 corresponding to the protrusions 34 in a surface, is disposed downstream of the transport direction of the metal foil 11 shown by the arrow. As a result, the protrusions 34 are formed on one face or both faces of the metal foil 11 on which the minute projections 36 have been formed in advance. At this time, the projections 36 in regions corresponding to the top faces of the protrusions 34 remain uncrashed, but the projections 36 in the other regions are compressed and crushed by the rollers 48A and 48B.

As described above, by forming the minute projections 36 on the surface of the metal foil 11 by a compression process in advance and then forming the larger protrusions 34 by a compression process, the minute projections 36 can be formed on the top faces of the protrusions 34 with a given shape.

The protrusions 34 and the projections 36 of the current collector 10E illustrated in FIG. 12 can also be formed by using dies and the like, instead of a compression process using rollers.

Also, the method of producing a positive or negative electrode and a non-aqueous electrolyte secondary battery using the current collector 10E is also the same as those described in Embodiments 1 to 5.

In the foregoing Embodiments, the projections 36 are formed on the top faces of the protrusions 34, but the adhesion between the active material and the current collector can be increased to some extent by roughening the top faces of the protrusions 34 by a surface treatment such as etching, dry etching, or blasting.

However, in the case of forming the projections 36 on the top faces of the protrusions 34, the adhesion between the current collector 10E and the active material layer can be controlled precisely, and thus the active material layer can be prevented from falling off the current collector more reliably.

Next, an Example according to Embodiment 6 of the invention is described. The invention is not to be construed as being limited to the Example.

### Example 2

A negative electrode for a lithium ion secondary battery was produced as follows.

A 20-μm thick copper foil was used as a metal foil for a current collector. Protrusions and projections as illustrated in FIG. 12 were formed on both faces of the metal foil. At this time, the protrusions and projections were formed by a compression process using two pair of rollers as illustrated in FIG. 15.

First, 3-μm high projections were formed on both faces of the metal foil. At this time, with the pitch (P3) in the horizontal direction and the pitch (P4) in the vertical direction in the figure set to 3 μm, the projections were formed in a regular arrangement as illustrated in FIG. 13. The pair of rollers (the rollers 46A and 46B in FIG. 15) used to form the projections had depressions which were formed by laser machining. The shape of the opening and cross-section of the depressions was substantially circular.

Thereafter, the metal foil with the projections formed on both faces was subjected to a compression process using a pair of rollers (the rollers 48A and 48B in FIG. 15) to form protrusions in the arrangement as illustrated in FIG. 12. At this time, the pitch (P1) in the width direction of the current collector (the horizontal direction in the figure) and the pitch (P2) in the longitudinal direction of the current collector (the vertical direction in the figure) were set to 20 μm. The shape of the opening and cross-section of the depressions formed in the surfaces of the rollers were substantially oval, with the major axis direction being in line with the width direction of the current collector.

A negative electrode current collector with a total thickness of 28 μm was produced in this manner.

Subsequently, using silicon with a purity of 99.9999% as a target and using a vapor deposition device equipped with an electron beam heating means, deposition was performed on both faces of the negative electrode current collector while oxygen with a purity of 99.7% was being introduced. As a result, a 10-μm thick negative electrode active material layer comprising SiO_{0.5} was formed on each face of the negative electrode current collector.

Thereafter, the negative electrode current collector was slit to a predetermined width, to obtain 200 negative electrodes for lithium ion secondary batteries.

### Example 3

Two hundred negative electrodes were produced in the same manner as in Example 2, except that the height and pitch of the projections formed on the top faces of the protrusions were set to 1 μm.

### Example 4

Two hundred negative electrodes were produced in the same manner as in Example 2, except that the height and pitch of the projections formed on the top faces of the protrusions were set to 5 μm.

### Comparative Examples 1 to 3

Two hundred negative electrodes were produced in the same manner as in Example 2, except that the height and pitch of the projections formed on the top faces of the protrusions were set to 0.5 μm (Comparative Example 1), 8 μm (Comparative Example 2), and 10 μm (Comparative Example 3).

Using 100 negative electrodes of each of Examples 2 to 4 and Comparative Examples 1 to 3, the strength required to peel the negative electrode active material layer from the negative electrode current collector was measured, and the average value was calculated. The results are shown in Table 1. The peel strength was measured as follows.

The negative electrode was cut to a size of 50×50 mm and fixed to a flat table. A double-sided tape was affixed to the whole area of the square end portion (10×10 mm) of a tester, and the end portion of the tester was bonded to the negative electrode active material layer on the upper face of the negative electrode fixed to the table. The tester was pushed against the negative electrode at a predetermined load, and the tester was pulled back from the negative electrode. At this time, the largest stress required to peel the negative electrode active material layer was measured as the peel strength.

Also, using 100 negative electrodes of each of Examples 2 to 4 and Comparative Examples 1 to 3, 100 coin-shaped lithium ion secondary batteries were produced. These batteries were subjected to 100 charge/discharge cycles in the same conditions as those of Example 1, and then all the cells were disassembled to check whether the negative electrode active material layers were peeled from the negative electrode current collector. The results are shown in Table 1.

TABLE 1

| | Height and | | Presence or absence |
|---|---|---|---|
| | pitch of | | of peeling of active |
| | projections | Peel strength | material layer after |
| | (μm) | (N/cm²) | 100 cycles |
| Comp. Example 1 | 0.5 | 205.8 | Present |
| Example 3 | 1 | 245 | Absent |
| Example 2 | 3 | 264.6 | Absent |
| Example 4 | 5 | 245 | Absent |
| Comp. Example 2 | 8 | 205.8 | Present |
| Comp. Example 3 | 10 | 186.2 | Present |

As shown in Table 1, the electrodes of Examples 2 to 4, in which the height and pitch of the projections are 1 to 5 μm, had a peel strength of the active material layer of 245 N/cm² or more. Also, the coin cells using these electrodes exhibited no peeling of the active material layer after the 100 charge/discharge cycles, having excellent cycle characteristics.

Contrary to this, Comparative Examples 1 to 3, in which the height and pitch of the projections are 0.5, 8, and 10 μm, respectively, had a peel strength of the active material layer of 205.8 or 186.2 N/cm², which was smaller than those of Examples 2 to 4. As a result, some of the coin-shaped lithium ion secondary batteries using these electrodes exhibited peeling of the active material layer after the 100 charge/discharge cycles, having inferior cycle characteristics.

In Examples 2 to 4 and Comparative Examples 1 to 3, the projections were formed in a regular arrangement, but forming projections in an irregular arrangement is also thought to produce essentially the same results.

Also, in Examples 2 to 4 and Comparative Examples 1 to 3, the major axis direction of the substantially oval protrusions was allowed to agree with the width direction of the current collector. Thus, by depositing the negative electrode active material slantwise from the direction parallel to the longitudinal direction of the negative electrode current collector, the active material could be efficiently deposited on the protrusions.

Also, in Example 2 in which 3-μm high projections were regularly formed on the top faces of the protrusions at a 3-μm pitch, the peel strength of the active material layer from the negative electrode current collector was the largest. To increase the adhesion, it is necessary to form a large number of minute projections at a predetermined interval in a regular arrangement. By setting the height of the projections to 3 μm and the pitch to 3 μm, a very good result was obtained.

### Example 5

Lithium ion secondary batteries were produced as follows.

A 15-μm thick aluminum foil was used as a material for a positive electrode current collector. Lithium cobaltate in which part of the cobalt was replaced with nickel and manganese was used as a positive electrode active material. A positive electrode mixture slurry was prepared by stirring and kneading 100 parts by weight of the positive electrode active material, 2 parts by weight of acetylene black serving as a conductive agent, 2 parts by weight of polyvinylidene fluoride as a binder, and a suitable amount of N-methyl-2-pyrrolidone with a double-arm kneader.

This positive electrode mixture slurry was applied onto both faces of the positive electrode current collector and dried to form a 82-μm thick active material layer on each face of the positive electrode current collector. The positive electrode current collector was pressed to a total thickness of 126 μm to obtain a positive electrode precursor with a 55.5-μm thick active material layer on each face. This was slit to a predetermined width to produce a positive electrode. In this manner, 200 positive electrodes were produced.

In the same manner as in Example 2, 200 negative electrodes were produced.

Using 100 positive electrodes and 100 negative electrodes thus produced, 100 lithium ion secondary batteries were produced in the same manner as in Example 1.

The 100 lithium ion secondary batteries thus produced and the remaining 100 positive electrodes and 100 negative electrodes were evaluated as follows.

First, the remaining 100 positive electrodes and 100 negative electrodes were disassembled and observed. As a result, both positive and negative electrodes were found to have no problem such as breakage of the current collector and fall-off of the active material layer.

Also, the produced 100 lithium ion secondary batteries were subjected to 300 charge/discharge cycles in the same conditions as those of Example 1. As a result, almost no deterioration in battery performance was observed. Further, the 100 lithium ion secondary batteries subjected to the 300 charge/discharge cycles were disassembled and their positive and negative electrodes were observed. As a result, they were found to have no problem such as deposition of lithium or fall-off of the active material layer.

This is probably because the negative electrode, which expands and contracts significantly due to charge/discharge compared with the positive electrode, was provided with protrusions and projections in such a manner that the protrusions were formed on the upper face of the current collector in a predetermined arrangement and that the projections with a height of 3 μm were formed on the top faces of the projections in a regular arrangement at a pitch of 3 μm. As such, when the columnar blocks of the negative electrode active material were formed by vapor deposition to form the active material layer, the contact area of the active material layer and the negative electrode current collector was enlarged, thereby resulting in increased adhesion between the active material layer and the negative electrode current collector.

Forming the projections on the top faces of the protrusions in an irregular arrangement is also thought to produce essentially the same results if the height and density of the projections are made equivalent to those of the above Examples.

### Embodiment 7

Next, Embodiment 7 of the invention is described.

FIG. 18 is a schematic sectional view of the structure of an electrode for a non-aqueous electrolyte secondary battery according to Embodiment 7 of the invention.

The electrode illustrated therein is a negative electrode 50 of a lithium ion secondary battery. It includes a current collector 10F with protrusions 52 formed on both faces in a predetermined arrangement and negative electrode active material layers 54 and 56 formed on both faces of the current collector 10F. The metal foil used as a material of the current collector 10F can be, for example, a copper foil.

The negative electrode active material layers 54 and 56 are composed of columnar blocks 20A and 20B of a negative electrode active material, respectively, which are formed on the top faces of the protrusions 52. The negative electrode active material layers 54 and 56 are supplemented with lithium, as described above. The negative electrode active material can be a compound containing silicon and oxygen, a compound containing tin and oxygen, or the like.

The columnar blocks 20A and 20B are formed slantwise relative to the surface of the current collector 10F, with suitable gaps 53A and 53B therebetween. Thus, when lithium is supplemented, it is possible to suppress cracking of the active material layers 54 and 56 caused by contact of the columnar blocks 20A and 20B due to expansion of the negative electrode active material.

Also, the thickness L1 of the active material layer 54 formed on one face (the upper face in the figure) of the current collector 10F is greater than the thickness L2 of the active material layer 56 formed on the other face (the lower face in the figure) of the current collector 10F. As a result, it is possible to prevent the negative electrode 50 from becoming significantly wavy due to irregular stress created inside the negative electrode active material layers 54 and 56 by variation in the amount of the negative electrode active material contained in the negative electrode active material layers 54 and 56 during lithium supplementation. That is, in the negative electrode 50, the internal stress of the negative electrode active material layer 54 is always greater than that of the negative electrode active material layer 56, and thus the negative electrode 50 only curls slightly.

In order to suppress the negative electrode 50 from becoming significantly wavy while minimizing the curl of the negative electrode 50, it is preferable to make the thickness L2 of the negative electrode active material layer 56 smaller than the thickness L1 of the negative electrode active material layer 54 by 5 to 10%.

Also, while the method of forming the columnar blocks 20A and 20B of active material is not particularly limited, it is preferably a dry process such as vapor deposition, sputtering, or CVD. Vapor deposition in particular has superior productivity and is thus advantageously applied to the method for producing electrodes for non-aqueous electrolyte secondary batteries which need to be produced in volume.

Referring now to FIG. 19, the method of forming the active material layers 54 and 56 is described.

FIG. 19 is a sectional view schematically showing the structure of a part of a vapor deposition device for forming an active material layer on a current collector by vapor deposition.

A vapor deposition device 58 illustrated therein includes a vacuum chamber 60 and a vacuum pump 62 for exhausting the air in the vacuum chamber 60. In the vacuum chamber 60, a supply roll 64 for unwinding the current collector 10F, a can roll 66, and a take-up roll 68 are disposed in a predetermined arrangement, and a deposition source 80, an oxygen supply nozzle 82, and masks 84 are disposed in a predetermined arrangement. The deposition source 80 comprises a crucible which contains a raw material for active material, such as silicon or tin, in the case of producing a negative electrode. Such a raw material for active material is heated and vaporized by resistance heating or application of an electron beam.

In the case of using silicon or tin as a raw material for active material, it is desirable that the purity thereof be higher. The oxygen supply nozzle 82 is designed to feed oxygen, supplied from an oxygen gas cylinder (not shown), into the vacuum chamber 60 via an orifice valve or a massflow controller. By supplying a predetermined amount of oxygen gas to the vicinity of the can roll 66 through the oxygen supply nozzle 82, deposition is performed in an atmosphere with a predetermined oxygen concentration. Also, it is preferable to dispose the oxygen supply nozzle 82 so that oxygen can be uniformly distributed to the vapor of the raw material for active material from the deposition source 80.

Also, the amount of oxygen supplied can be changed as appropriate, depending on production conditions such as the shape of the vacuum chamber 60, the pumping capacity of the vacuum pump, the evaporation speed of the raw material for active material, and the width of the active material layer formed on the current collector. For example, in the case of using the vacuum chamber 60 with a volume of 0.4 m³ and an oil diffusion pump with a pumping speed of 2.2 m³/s as the vacuum pump 62, the amount of oxygen gas to be supplied by the oxygen supply nozzle 82 is approximately 0.0005 to 0.005 m³/s at 25° C. and 1 atmosphere.

The current collector 10F unwound from the supply roll 64 is given a predetermined tension by tension rollers 86 and 88 to make it into contact with the outer surface of the can roll 66, and is transported to the longitudinal direction. Only the vapor of the raw material for active material having passed through the masks 84 from the deposition source 80 reaches the surface of the current collector 10F. As a result, in an oxygen atmosphere, a negative electrode active material layer comprising a silicon oxide or a tin oxide is formed on the surface of the current collector 10F. The current collector 10F with the negative electrode active material layer formed on the surface is rewound by the take-up roll 68.

After the negative electrode active material layer is formed on one face of the current collector 10F, the current collector 10F is turned upside down and set around the supply roll 64. Then, the raw material for active material is again deposited on the other face to form a negative electrode active material layer.

At this time, it is preferable to form the negative electrode active material layer 56 before forming the negative electrode active material layer 54 for the following reason. Since the vapor of the raw material for active material from the deposition source 80 is very hot, how the negative electrode 50 with the deposited negative electrode active material is cooled is important to suppress the negative electrode 50 from becoming wrinkled and wavy. By forming the thinner negative electrode active material layer 56 with a high cooling efficiency in advance, it is possible to suppress the negative electrode plate from becoming wrinkled and wavy.

After completion of the formation of the negative electrode active material layers on both faces of the current collector 10F, a predetermined amount of lithium is deposited on the negative electrode active material layers on both faces of the current collector 10F, using another vacuum vapor deposition device. Thereafter, the current collector 10F is slit to predetermined width and length to obtain the negative electrode 50.

The thickness of the negative electrode active material layers on both faces of the current collector 10F can be controlled by adjusting at least one of the amount of heating of the deposition source 80 and the transport speed of the current collector 10F. Increasing the amount of heating of the deposition source 80 results in increased thickness of the negative electrode active material layer, while decreasing the amount of heating results in decreased thickness of the negative electrode active material layer. Also, slowing the transport speed of the current collector 10F results in increased thickness of the negative electrode active material layer, while increasing the transport speed results in decreased thickness of the negative electrode active material layer.

Also, as the material of the current collector 10F, it is preferable to use foil made of copper, nickel, or the like. The thickness of the foil is preferably 4 to 30 μm, and more preferably 5 to 10 μm, in terms of the strength, the volumetric efficiency of the battery, ease of handling, etc.

In order to increase the adhesion of the negative electrode active material layer, it is preferable to provide the surface of the foil with the protrusions 52 with a surface roughness (arithmetic mean roughness Ra (Japan Industrial Standard: JIS B0601-1994), hereinafter the same) of approximately 0.1 to 4 μm. More preferably, the surface roughness is 0.4 to 2.5 μm. Such surface roughness can be measured by using, for example, a surface roughness meter.

Next, the non-aqueous electrolyte secondary battery using the electrode of this embodiment is described.

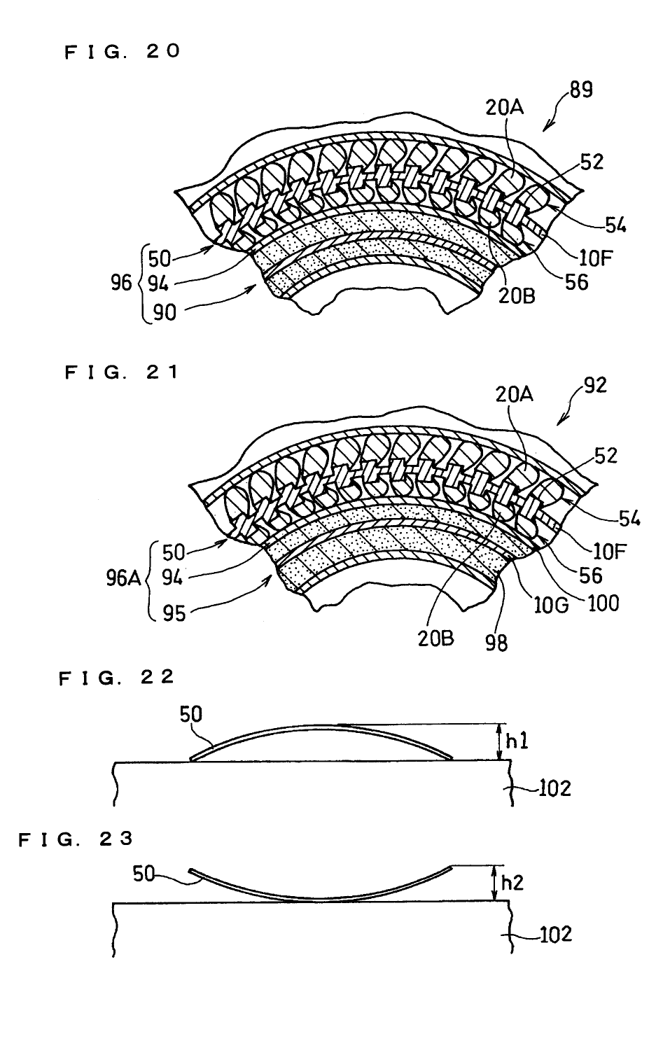

FIG. 20 is a sectional view of a part of the non-aqueous electrolyte secondary battery of this embodiment. In a battery 89 illustrated therein, an electrode assembly 96 is produced by spirally winding a positive electrode 90 using a lithium-containing transition metal oxide as a positive electrode active material and the negative electrode 50 of FIG. 18, with a separator 94 interposed therebetween.

At this time, the negative electrode 50 is wound so that the thicker negative electrode active material layer 54 is positioned on the outer side while the thinner negative electrode active material layer 56 is positioned on the inner side. It is thus possible to alleviate the internal stress of the negative electrode active material layer 56 on the inner side which is subjected to a larger compressive stress due to the difference in curvature during lithium supplementation or charge. As a result, the breakage and buckling of the negative electrode 50 can be suppressed.

### Embodiment 8

FIG. 21 is a sectional view schematically showing the structure of a part of the non-aqueous electrolyte secondary battery according to Embodiment 8 of the invention. In a battery 92 illustrated therein, the negative electrode 50 has the same structure as that of the battery 89 of FIG. 20. A positive electrode 95 has positive electrode active material layers 98 and 100 formed on both faces of a current collector 10G, but the amount of the positive electrode active material contained in the positive electrode active material layer 98 on the inner side is larger than that of the positive electrode active material layer 100 on the outer side. That is, since the negative electrode active material layer 56 on the inner side of the negative electrode 50 is thinner, the opposite positive electrode active material layer 100 on the outer side of the positive electrode 95 contains a smaller amount of the positive electrode active material. On the other hand, since the negative electrode active material layer 56 on the outer side of the negative electrode 50 is thicker, the opposite positive electrode active material layer 98 on the inner side of the positive electrode 95 contains a larger amount of the positive electrode active material.

Such structure allows the electrical capacities of the positive electrode 95 and the negative electrode 50 to be balanced. It is thus possible to reduce the deterioration of the positive electrode 95 and the negative electrode 50 due to charge/discharge cycles and suppress breakage and buckling of the electrodes more effectively.

Next, Examples according to Embodiments 7 and 8 are described. However, the invention is not to be construed as being limited to these Examples.

### Example 6

A negative electrode was produced as follows.

A negative electrode current collector with the same structure as that of the current collector 10F illustrated in FIG. 18 was prepared as the negative electrode current collector. A copper foil was used as the metal foil serving as the material of the negative electrode current collector. The surface roughness (arithmetic mean roughness Ra; hereinafter the same) was set to 0.8 μm. The thickness of the negative electrode current collector including the protrusions on the surfaces was set to 10 μm.

The negative electrode current collector was set around a supply roll, which was then set in a vapor deposition device with the same structure as that of the vapor deposition device 58 illustrated in FIG. 19 to form a negative electrode active material layer on one face (the upper face of the current collector 10F illustrated in FIG. 18) in advance.

The vacuum chamber of the vapor deposition device, having a volume of 0.4 m³, was evacuated to a vacuum of 5×10⁻⁵ Pa by a vacuum pump with a pumping speed of 2.2 m³/s. Thereafter, in the vacuum chamber, the negative electrode current collector unwound from the supply roll was transported in the longitudinal direction at a speed of 1 cm/min while it was kept in contact with the outer surface of the can roll.

A carbon crucible, in which silicon with a purity of 99.998% was disposed as a raw material for negative electrode active material, was used as a deposition source. This was heated to 1800° C. by an electron beam, and at the same time, an amount of oxygen equivalent to 0.001 m³/s at 25° C. and 1 atmosphere was introduced into the vacuum chamber via an oxygen supply nozzle. The position of the opening between the masks was set so as to allow the vapor of the raw material for negative electrode active material to reach the surface of the negative electrode current collector from a slanting direction on the same side, so that a negative electrode active material layer with a thickness of 10 μm (theoretical value) was formed on the other face of the negative electrode current collector.

The negative electrode current collector with the active material layer formed on one face was rewound around the take-up roll.

Next, the pressure inside the vacuum chamber was allowed to return to the atmospheric pressure. In order to form a negative electrode active material layer on the other face of the negative electrode current collector (the lower face of the current collector 10F illustrated in FIG. 18), the rewound negative electrode current collector was set in the vacuum chamber, which was again evacuated to a vacuum of 5×10⁻⁵ Pa. Thereafter, while the negative electrode current collector was being transported at a speed of 1.05 cm/min in the longitudinal direction, a negative electrode active material layer with a thickness of 9.5 μm (theoretical value) was formed on the other face of the negative electrode current collector in the same manner as described above.

The negative electrode with the negative electrode active material layers formed on both faces was set in another vapor deposition device in which lithium was disposed in the deposition source. The deposition source was heated to 400° C. by resistance heating to deposite lithium on both faces of the negative electrode. The negative electrode was taken out from the vapor deposition device and then slit to a predetermined width to produce 10 negative electrodes with a length of 1 m for non-aqueous electrolyte secondary batteries.

### Example 7

The transport speed of the negative electrode current collector was set to 1.07 cm/min in forming a negative electrode active material layer with a thickness of 9.3 μm (theoretical value) on the other face of the negative electrode current collector (the lower face of the current collector 10F illustrated in FIG. 18). Except for this, in the same manner as in Example 6, 10 negative electrodes with a length of 1 m for non-aqueous electrolyte secondary batteries were produced.

### Example 8

The transport speed of the negative electrode current collector was set to 1.09 cm/min in forming a negative electrode active material layer with a thickness of 9.1 μm (theoretical value) on the other face of the negative electrode current collector (the lower face of the current collector 10F illustrated in FIG. 18). Except for this, in the same manner as in Example 6, 10 negative electrodes with a length of 1 m for non-aqueous electrolyte secondary batteries were produced.

### Example 9

The transport speed of the negative electrode current collector was set to 1.1 cm/min in forming a negative electrode active material layer with a thickness of 9 μm (theoretical value) on the other face of the negative electrode current collector (the lower face of the current collector 10F illustrated in FIG. 18). Except for this, in the same manner as in Example 6, 10 negative electrodes with a length of 1 m for non-aqueous electrolyte secondary batteries were produced.

### Comparative Example 4

The transport speed of the negative electrode current collector was set to 1.0 cm/min in forming a negative electrode active material layer with a thickness of 10 μm (theoretical value) on the other face of the negative electrode current collector (the lower face of the current collector 10F illustrated in FIG. 18). Except for this, in the same manner as in Example 6, 10 negative electrodes with a length of 1 m for non-aqueous electrolyte secondary batteries were produced.

### Comparative Example 5

The transport speed of the negative electrode current collector was set to 1.01 cm/min in forming a negative electrode active material layer with a thickness of 9.9 μm (theoretical value) on the other face of the negative electrode current collector (the lower face of the current collector 10F illustrated in FIG. 18). Except for this, in the same manner as in Example 6, 10 negative electrodes with a length of 1 m for non-aqueous electrolyte secondary batteries were produced.

### Comparative Example 6

The transport speed of the negative electrode current collector was set to 1.02 cm/min in forming a negative electrode active material layer with a thickness of 9.8 μm (theoretical value) on the other face of the negative electrode current collector (the lower face of the current collector 10F illustrated in FIG. 18). Except for this, in the same manner as in Example 6, 10 negative electrodes with a length of 1 m for non-aqueous electrolyte secondary batteries were produced.

### Comparative Example 7

The transport speed of the negative electrode current collector was set to 1.11 cm/min in forming a negative electrode active material layer with a thickness of 8.9 μm (theoretical value) on the other face of the negative electrode current collector (the lower face of the current collector 10F illustrated in FIG. 18). Except for this, in the same manner as in Example 6, 10 negative electrodes with a length of 1 m for non-aqueous electrolyte secondary batteries were produced.

### Comparative Example 8

The transport speed of the negative electrode current collector was set to 1.12 cm/min in forming a negative electrode active material layer with a thickness of 8.8 μm (theoretical value) on one face of the negative electrode current collector. Except for this, in the same manner as in Example 6, 10 negative electrodes with a length of 1 m for non-aqueous electrolyte secondary batteries were produced.

Using the 10 negative electrodes of each of Examples 6 to 9 and Comparative Examples 4 to 8 for non-aqueous electrolyte secondary batteries, whether they were wavy or the amount of curl were checked. Table 2 shows the results.

Also, with respect to each of Examples 6 to 9 and Comparative Examples 4 to 8, the ratio (D) of decrease of the thickness (L2) of the negative electrode active material layer on the other face of the negative electrode current collector to the thickness (L1) of the negative electrode active material layer on one face was calculated. Table 2 shows the results.

The ratio (D) was calculated from the following formula (I).

D=100×(L1−L2)/L1 (1)

In order to check whether the electrodes were wavy, the electrodes were placed in a surface plate 102 as illustrated in FIGS. 22 to 24 and observed.

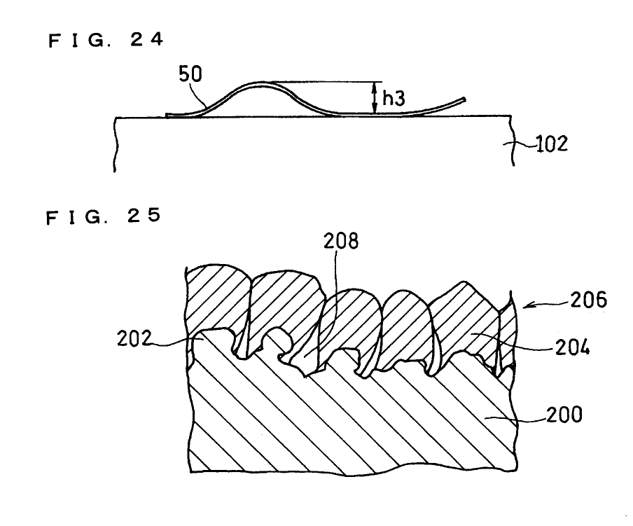

To obtain the amount of curl of the negative electrode 50 curling in one direction, the electrode was placed on the surface plate 102 and the greatest height h1 or h2 was measured as illustrated in FIG. 22 and FIG. 23. Also, in the case of the wavy negative electrode 50, the negative electrode 50 was placed on the surface plate 102 and the greatest height h3 was measured as illustrated in FIG. 24.

Also, using the 10 negative electrodes of each of Examples 6 to 9 and Comparative Examples 4 to 8 for non-aqueous electrolyte secondary batteries, the thickness of each active material layer was actually measured at 10 locations. Table 3 shows the results.

TABLE 2

| | | | Ratio D of | | |
|---|---|---|---|---|---|
| | | | difference | | |
| | Thickness | Thickness | in thickness | | |
| | L2 | L1 | between | | |
| | of active | of active | active | | |
| | material | material | material | | |
| | layer on the | layer on | layers on | Wavy | Amount |
| | other face | one face | both faces | or not | of curl |
| | (μm) | (μm) | (%) | (%) | (mm) |
| Comparative | 10 | 10 | 0 | 60 | 10 |
| Example 4 | | | | | |
| Comparative | 9.9 | 10 | 1 | 40 | 8 |
| Example 5 | | | | | |
| Comparative | 9.8 | 10 | 2 | 10 | 5 |
| Example 6 | | | | | |
| Example 6 | 9.5 | 10 | 5 | 0 | 2 |
| Example 7 | 9.3 | 10 | 7 | 0 | 3 |
| Example 8 | 9.1 | 10 | 9 | 0 | 5 |
| Example 9 | 9 | 10 | 10 | 0 | 7 |
| Comparative | 8.9 | 10 | 11 | 0 | 15 |
| Example 7 | | | | | |
| Comparative | 8.8 | 10 | 12 | 0 | 30 |
| Example 8 | | | | | |

TABLE 3

| | Actually measured | Actually measured |
|---|---|---|
| | thickness of active material | thickness of active material |
| | layer on the other face (μm) | layer on one face (μm) |
| Comparative | 9.8 to 10.2 | 9.8 to 10.2 |
| Example 4 | | |
| Comparative | 9.7 to 10.1 | 9.8 to 10.2 |
| Example 5 | | |
| Comparative | 9.5 to 9.9 | 9.8 to 10.2 |
| Example 6 | | |
| Example 6 | 9.3 to 9.7 | 9.8 to 10.2 |
| Example 7 | 9.1 to 9.5 | 9.8 to 10.2 |
| Example 8 | 8.9 to 9.3 | 9.8 to 10.2 |
| Example 9 | 8.8 to 9.2 | 9.8 to 10.2 |
| Comparative | 8.6 to 9.0 | 9.8 to 10.2 |
| Example 7 | | |
| Comparative | 8.3 to 8.7 | 9.8 to 10.2 |
| Example 8 | | |

As is clear from Table 2, in Comparative Examples 4 to 6 with a ratio D of smaller than 5%, some of the electrodes became wavy. The percentage of occurrence of this problem decreases as the ratio D increases. In Examples 6 to 9 and Comparative Examples 7 and 8 with a ratio D of 5% or more, none of the negative electrodes became wavy.

The reason why the electrode becomes wavy is that the thicknesses of the active material layers at the respective locations of the electrode are not uniform, as shown in Table 3. As a result, the amount of expansion of the active material layer on one face is larger than that on the other face at some of the locations, but is smaller at other locations, and this occurs irregularly to make the electrode wavy.

When the ratio D is 5% or more, the amount of expansion of the active material layer on one face is always larger than that on the other face. In this case, the deforming direction becomes constant and the electrode does not become wavy.

Also, when the ratio D is in the range of 0 to 5%, as the difference increased, the amount of curl decreased. The decrease in the amount of curl is due to a decrease in waviness.

On the other hand, in the case of Examples 7 to 9 and Comparative Examples 7 and 8 with a ratio D of more than 5%, as the ratio D increases, the amount of curl also increases. This is because as the ratio D increases, the difference in the amount of expansion between the active material layers on both faces also increases.

Accordingly, it is preferable to set the ratio D in the range of 5 to 10% in order to prevent the electrode from becoming wavy while suppressing the amount of curl.

### Example 10

A lithium ion secondary battery was produced as follows.

A negative electrode with a 10-μm thick negative electrode active material layer on one face and a 9.1-μm thick negative electrode active material layer on the other face was produced in the same manner as in Example 7.

A positive electrode mixture slurry was prepared by stirring and kneading 100 parts by weight of lithium cobaltate serving as a positive electrode active material, 2 parts by weight of acetylene black as a conductive agent, 2 parts by weight of polyvinylidene fluoride as a binder, and a suitable amount of N-methyl-2-pyrrolidone with a double-arm kneader.

This positive electrode mixture slurry was then applied onto both faces of a positive electrode current collector comprising a 15-μm thick aluminum foil and dried to form a 85-μm thick active material layer on each face of the positive electrode current collector.

The positive electrode current collector was pressed to a total thickness of 143 μm to obtain a positive electrode precursor with a 64.0-μm thick active material layer on each face. This was slit to a predetermined width to produce a positive electrode.

Using the negative electrode and the positive electrode produced in the above manner, a lithium ion secondary battery as illustrated in FIG. 11 was produced. More specifically, the positive electrode and the negative electrode were spirally wound with a separator comprising a 20-μm thick polyethylene microporous film interposed therebetween, to form an electrode assembly. At this time, the negative electrode was wound so that the 10.0-μm thick negative electrode active material layer was positioned on the outer side while the 9.1-μm thick negative electrode active material layer was positioned on the inner side.

Except for this, in the same manner as in Example 1, 100 lithium ion secondary batteries were produced.

### Example 11

A negative electrode and a positive electrode were produced in the same manner as in Example 10. In forming the positive electrode, the positive electrode mixture slurry was applied so that the thickness of the positive electrode active material layer on one face was 70 μm while the thickness of the active material layer on the other face was 100 μm. The resultant positive electrode current collector was pressed to a total thickness of 143 μm, so that the thickness of the positive electrode active material layer on one face was 60.7 μm while the thickness on the other face was 67.4 μm.

Using the negative electrode and the positive electrode produced in the above manner, a lithium ion secondary battery as illustrated in FIG. 11 was produced. More specifically, the positive electrode and the negative electrode were spirally wound with a separator comprising a 20-μm thick polyethylene microporous film interposed therebetween. At this time, the negative electrode was wound so that the 10.0-μm thick negative electrode active material layer was positioned on the outer side while the 9.1-μm thick negative electrode active material layer was positioned on the inner side. The positive electrode was wound so that the 67.4-μm thick positive electrode active material layer was positioned on the inner side while the 60.6-μm thick positive electrode active material layer was positioned on the outer side.

Except for this, in the same manner as in Example 1, 100 lithium ion secondary batteries were produced.

### Comparative Example 10

A negative electrode was produced in the same manner as in Example 6. At this time, the thickness of the negative electrode active material layer on one face was set to 9.5 μm while the thickness of the negative electrode active material layer on the other face was also set to 9.5 μm.

A positive electrode was produced in the same manner as in Example 10. At this time, the thicknesses on both faces of the positive electrode current collector were set to 64 μm.

Except for this, in the same manner as in Example 10, 100 lithium ion secondary batteries were produced.

In Examples 10 and 11 and Comparative Example 10, the initial capacity was measured, and then 500 charge/discharge cycles were applied. The capacity obtained upon completion of the 500 charge/discharge cycles in the same conditions as those of Example 1 was compared with the initial capacity to calculate the capacity retention rate, and the average value was calculated.

Further, the lithium ion secondary batteries after the 500 charge/discharge cycles were disassembled to check if their negative electrodes had problems such as breakage, buckling, lithium deposition, and fall-off of the active material layer.

Table 4 shows the results.

TABLE 4

| | Thickness L2 of | Thickness L1 of | Thickness of | Thickness of | Capacity | Percentage of occur- |
|---|---|---|---|---|---|---|
| | negative electrode | negative electrode | positive electrode | positive electrode | retention | rence of problem of |
| | active material layer | active material layer | active material layer | active material layer | rate after 500 | negative electrode |
| | on the other face (μm) | on one face (μm) | on the other face (μm) | on one face (μm) | cycles (%) | after 500 cycles (%) |
| Example 10 | 9.1 | 10 | 64 | 64 | 84 | 0 |
| Example 11 | 9.1 | 10 | 67.4 | 60.7 | 91 | 0 |
| Comparative | 9.5 | 9.5 | 64 | 64 | 50 | 75 |
| Example 10 | | | | | | |

As is clear from Table 4, Examples 10 and 11 achieved good capacity retention rates after 500 cycles. In, Examples 10 and 11, their negative electrodes exhibited no problems such as breakage, buckling, lithium deposition, or fall-off of the active material layer. Also, even after the 500 charge/discharge cycles, the negative electrodes exhibited no problems such as breakage, buckling, lithium deposition, or fall-off of the negative electrode active material layer.

This is probably due to the following reasons. In forming the electrode assembly, the thickness of the negative electrode active material layer on the inner side was decreased, thereby making it possible to reduce the difference in stress resulting from the difference in curvature between the inner side and the outer side of the wound electrode. Also, the thickness of the negative electrode active material layer on the inner side, which is subjected to a larger compressive stress during charge, was decreased to reduce the stress, thereby making it possible to suppress breakage or buckling of the electrode. As a result, the capacity could be maintained even after the 500 cycles.

Also, Example 11, in particular, has a good capacity retention rate after the 500 charge/discharge cycles. This is probably because the thicknesses of the positive electrode active material layers were changed according to the thicknesses of the opposite negative electrode active material layers, thereby resulting in an improved balance of electrical capacity between the positive electrode and the negative electrode and a good balance of expansion and contraction between the positive electrode and the negative electrode.

On the other hand, in the case of Comparative Example 10 in which the thicknesses of the active material layers on both faces of the negative electrode and the positive electrode were made equal, the capacity retention rate after the 500 charge/discharge cycles is inferior to those of Examples 10 and 11, as shown in Table 4. Also, the negative electrodes were observed to have problems such as breakage, buckling, lithium deposition, or fall-off of the active material layer.

Accordingly, it can be said that making the thicknesses of the active material layers on both faces of the negative electrode different to alleviate the stress of expansion and contraction during charge/discharge is effective in preventing problems such as cycle characteristics of non-aqueous electrolyte secondary batteries and breakage of the negative electrode.

### INDUSTRIAL APPLICABILITY

The current collector for a non-aqueous electrolyte secondary battery according to the invention can be safely handled. In addition, the use of the current collector can provide an electrode for a non-aqueous electrolyte secondary battery and a non-aqueous electrolyte secondary battery in which the adverse effect of stress inside the electrode due to charge/discharge is reduced to provide high safety. Therefore, the invention is advantageously applicable to portable power sources which are required to provide higher capacities as electronic devices and communications devices are increasingly becoming more multifunctional.

### REFERENCE SIGNS LIST

10 Current collector
12, 34 Protrusion
20 Columnar block
36 Projection
70 Battery
72 Seal member
75 Positive electrode
76 Negative electrode
77 Separator

1. A current collector for a non-aqueous electrolyte secondary battery, comprising:
a metal foil; and
a plurality of protrusions formed on at least one face of the metal foil,
wherein each of the protrusions, when viewed from a direction perpendicular to a surface of the metal foil, has such a shape that both end portions in each of two orthogonal axial directions protrude outward while middle portions between the end portions that are adjacent in a circumferential direction of the protrusion are recessed inward.

2. The current collector for a non-aqueous electrolyte secondary battery in accordance with claim 1, wherein the protrusions are aligned on the surface of the metal foil in a zigzag.

3. The current collector for a non-aqueous electrolyte secondary battery in accordance with claim 1,
wherein the end portions of each of the protrusions in each of the two axial directions have the same height, and
the end portions in one of the two axial directions have a greater height than the end portions in the other axial direction.

4. The current collector for a non-aqueous electrolyte secondary battery in accordance with claim 3,
wherein each of the protrusions has a main top face between the end portions in said one axial direction,
the height of the main top face is equal to or greater than that of the end portions in said one axial direction, and
the end portions in the other axial direction are disposed on both sides of the main top face.

5. The current collector for a non-aqueous electrolyte secondary battery in accordance with claim 3,
wherein the main top face has an indentation adjacent to each of the end portions in the other axial direction, and
at least a part of the indentation is spherical.

6. The current collector for a non-aqueous electrolyte secondary battery in accordance with claim 1, wherein at least a side face of each of the middle portions of the protrusions is slanted in such a manner that it is gradually recessed inward toward a top.

7. The current collector for a non-aqueous electrolyte secondary battery in accordance with claim 1,
wherein the protrusions are formed by applying a compression process to the metal foil, and
top faces of the protrusions maintain the surface roughness of the metal foil which has not been subjected to the compression process.

8. A current collector for a non-aqueous electrolyte secondary battery, comprising:
a metal foil; and
a plurality of protrusions formed on at least one face of the metal foil,
wherein each of the protrusions has a plurality of projections on a top face.

9. The current collector for a non-aqueous electrolyte secondary battery in accordance with claim 8, wherein the projections are arranged regularly on the top faces of the protrusions.

10. The current collector for a non-aqueous electrolyte secondary battery in accordance with claim 8, wherein the projections are arranged irregularly on the top faces of the protrusions.

11. The current collector for a non-aqueous electrolyte secondary battery in accordance with claim 8, wherein the projections have a height of 1 to 5 μm.

12. The current collector for a non-aqueous electrolyte secondary battery in accordance with claim 8, wherein the interval between the adjacent projections is 1 to 5 μm.

13. An electrode for a non-aqueous electrolyte secondary battery, comprising:
the current collector for a non-aqueous electrolyte secondary battery recited claim 1; and
a positive electrode active material comprising a lithium-containing transition metal oxide, or a negative electrode active material comprising a material capable of retaining lithium, the active material being carried on the current collector.

14. A non-aqueous electrolyte secondary battery comprising:
an electrode assembly comprising a positive electrode, a negative electrode, and a separator interposed between the two electrodes, which are layered or wound;
a non-aqueous electrolyte;
a battery case with an opening for housing the electrode assembly and the non-aqueous electrolyte; and
a seal member for sealing the opening,
wherein at least one of the positive electrode and the negative electrode comprises the electrode for a non-aqueous electrolyte secondary battery recited in claim 13.

15. A method for producing a current collector for a non-aqueous electrolyte secondary battery, comprising the steps of:
(a) compressing a metal foil by a pair of rollers at least one of which has a plurality of depressions to form a plurality of projections on at least one face of the metal foil; and
(b) compressing the metal foil by another pair of rollers at least one of which has a plurality of depressions to form protrusions on the face of the metal foil having the projections, the protrusions being larger in size than the projections.

16. The method for producing a current collector for a non-aqueous electrolyte secondary battery in accordance with claim 15, wherein the depressions are formed in the roller by at least one selected from the group consisting of laser machining, etching, dry etching, and blasting.

17. An electrode for a non-aqueous electrolyte secondary battery, comprising:
a current collector comprising a metal foil and a plurality of protrusions formed on both faces of the metal foil in a predetermined arrangement; and
active material layers formed on both faces of the current collector,
wherein each of the active material layers is a group of columnar blocks of an active material formed on the protrusions, and
the thickness of the active material layer on one face of the current collector is greater than that of the active material layer on the other face.

18. The electrode for a non-aqueous electrolyte secondary battery in accordance with claim 17, wherein the active material layers comprise a compound containing silicon and oxygen or a compound containing tin and oxygen.

19. The electrode for a non-aqueous electrolyte secondary battery in accordance with claim 17, wherein the columnar blocks extend from top faces of the protrusions slantwise with respect to a direction perpendicular to a surface of the metal foil.

20. The electrode for a non-aqueous electrolyte secondary battery in accordance with claim 17, wherein the thickness of the active material layer on one face of the current collector is smaller than that of the active material layer on the other face by 5 to 10%.

21. A non-aqueous electrolyte secondary battery comprising:
an electrode assembly comprising a positive electrode, a negative electrode, and a separator interposed between the two electrodes, which are wound;
a non-aqueous electrolyte;
a battery case with an opening for housing the electrode assembly and the non-aqueous electrolyte; and
a seal member for sealing the opening,
wherein the negative electrode comprises the electrode for a non-aqueous electrolyte secondary battery recited in claim 17, and
the electrode assembly is produced by winding the negative electrode so that the active material layer on said one face is positioned on the inner side while the active material layer on the other face is positioned on the outer side.

22. The non-aqueous electrolyte secondary battery in accordance with claim 21,
wherein the positive electrode has active material layers on both faces,
the amount of active material contained in the active material layer on one face of the positive electrode is smaller than that of the active material layer on the other face, and
the electrode assembly is produced by winding the positive electrode so that the active material layer on said one face is positioned on the outer side while the active material layer on the other face is positioned on the inner side.

23. A method for producing an electrode for a non-aqueous electrolyte secondary battery, comprising the steps of:
(a) preparing a current collector comprising a long-strip like metal foil and a plurality of protrusions formed on both faces of the metal foil in a predetermined arrangement;
(b) preparing a silicon- or tin-containing raw material for active material;
(c) evaporating the raw material for active material from a deposition source in a vacuum deposition chamber;
(d) transporting the current collector in a longitudinal direction in the vacuum deposition chamber;
(e) supplying oxygen to a vicinity of the current collector in the vacuum deposition chamber; and
(f) depositing the raw material for active material on a surface of the current collector to form an active material layer,
wherein when the active material layer is formed on both faces of the current collector, the raw material for active material is deposited on the current collector so that the thickness of the active material layer formed on one face of the current collector is smaller than that of the active material layer formed on the other face of the current collector.

24. The method for producing an electrode for a non-aqueous electrolyte secondary battery in accordance with claim 23, wherein when the active material layer is formed on one face of the current collector, the current collector is transported at a higher speed than when the active material layer is formed on the other face of the current collector.

25. The method for producing an electrode for a non-aqueous electrolyte secondary battery in accordance with claim 23, wherein when the active material layer is formed on one face of the current collector, the deposition source is heated with a smaller amount of heat than when the active material layer is formed on the other face of the current collector.
